(19) United States
(12) Patent Application Publication
(10) Pub. No.: US 2019/0178479 A1
(43) Pub. Date: Jun. 13, 2019

(54) Set Light Fixture and Application of Same

(71) Applicant: Jiang LIU, Beijing (CN)

(72) Inventor: Jiang LIU, Beijing (CN)

(21) Appl. No.: 16/309,911

(22) PCT Filed: Dec. 23, 2016
(86) PCT No.: PCT/CN2016/111611

§ 371 Date: Dec. 13, 2018

(51) Int. Cl. F21V 21/30; F21L 4/04; G03B 15/02; F21V 21/14; F21V 29/70

(52) U.S. Cl. CPC F21V 21/30; F21L 4/04; F21Y 2115/10; F21V 21/145; F21V 29/70; G03B 15/02

(57) ABSTRACT

A set light fixture includes at least one adjustment supporting device, at least one light source device, at least one light control driver, and at least one battery holder. The adjustment supporting device is used to adjust angle and height of the set light fixture. The light source device is removably mounted on the adjustment supporting device. The light control driver is provided on the adjustment supporting device and is electrically connected to the light source device. The battery holder is electrically connected to the light control driver.

### CROSS-REFERENCE TO RELATED APPLICATIONS

This is a non-provisional application that claims the benefit of priority under 35 U.S.C. § 371 to international application number PCT/CN2016/111611, international filing date Dec. 23 2016, wherein the entire contents of which are expressly incorporated herein by reference.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to an illumination device, and more particularly to a set light fixture for conveniently changing an illumination angle and an illumination height to meet needs of a variety of situations where illumination or special light sources are required, particularly in various photographing or imaging environments.

### Description of Related Arts

The use of lamps is very extensive, and the products that are extended into uses corresponding to different needs are numerous. It is worth mentioning that in recent years, due to the rise of various industries such as photography, imaging, entertainment and live broadcasting, the lighting effects further has an impact on the quality of the final imaging products of various photographing modules or camera modules. So the demand for good lighting effects is relatively increased, especially when LED is introduced into lamps for film and television circumstances and lamps for photographing. Because LED has the advantages of energy saving, environmental protection and long service life, it is greatly widely used in studios, indoor and outdoor video shooting, indoor and outdoor photography and so on. However, the traditional LED lamps for photographing or imaging circumstances are generally heavy, and the types of illumination types are relatively limited, and wires are needed to be directly connected to the power source, which results in difficulty in transportation. In addition, if it is necessary to realize different lighting effects in actual situations, the traditional LED lamps for photographing or imaging circumstances are also difficult to achieve the objects, such as the adjustment of the splicing, replacement, illumination angle range, spot size, and color temperature of the light source according to needs. However, the actual environments of photographing and imaging circumstances are complex and diverse, it is usually necessary to replace the light source or adjust the angle, position, and color temperature, etc. according to the objective needs of different environments and the subjective needs of different themes, scenes and ideas, etc. by the photographers. However, the conventional LED lamps for photographing or imaging circumstance are difficult to meet the needs of a variety of complex and varied photographing or imaging environments.

### SUMMARY OF THE PRESENT INVENTION

The invention is advantageous in that it provides a set light fixture, so as to conveniently adapt to a variety of applications requiring illumination or special light sources, particularly be suitable for use in a variety of photographing or imaging environments.

Another advantage of the invention is to provide a set light fixture, wherein at least a light source device is supported by an adjustment supporting device, so as to allow the light source device to easily change an illumination angle or illumination height, and to easily set a position.

Another advantage of the invention is to provide a set light fixture, which further comprises a portable power device, which is more convenient for use in outdoor photographing.

Another advantage of the invention is to provide a set light fixture, wherein the light source device has a splicing function, so as to increase an illumination area.

Another advantage of the invention is to provide a set light fixture, which comprises an adapter device for cooperating with the adjusting support to enhance the utility of the light source device. Further, the adapter device detachably mounts the light source device to the adjustment supporting device. Therefore, when the adapter device is disposed at the adjustment supporting device, the light source device can be rotated to change a direction by the adapter device; when the adapter device is separated from the adjustment supporting device, the light source device can be attracted to any plane of the object that can be magnetically attracted by the adapter device. It can be understood that the adapter device comprises a magnetic unit such as a magnet.

Additional advantages and features of the invention will become apparent from the description which follows, and may be realized by means of the instrumentalities and combinations particular point out in the appended claims.

According to the present invention, the foregoing and other objects and advantages are attained by a set light fixture comprising: at least an adjustment supporting device which achieves adjustment of an angle and a height of the set light fixture; at least a light source device detachably mounted to the adjustment supporting device; at least a light control driver arranged at the adjustment supporting device and electrically connected to the light source device; and at least a battery holder electrically connected to the light control drive.

According to a preferred embodiment of the present invention, the adjustment supporting device comprises a handle, a holder and an adjustment screw, wherein the light source device is arranged at the handle, wherein the handle is rotatably mounted to the holder, wherein after the handle is adjusted with angle relative to the holder, the adjustment screw is arranged for fixation.

According to a preferred embodiment of the present invention, the light source device comprises a bottom plate, a plurality of LED illumination members, a protective film, a plurality of wrap corners, and a plurality of supporting frames, wherein the plurality of the LED illumination members is arranged in an array manner at the bottom plate, wherein the protective film is covered on the plurality of LED illumination members by a vacuum molding process, wherein the plurality of wrap corners are respectively disposed at corresponding corner positions of the bottom plate, wherein each of the supporting frames is respectively arranged between two the wrap corners.

According to a preferred embodiment of the present invention, the bottom plate is made of a flexible material.

According to a preferred embodiment of the present invention, the support frame is embodied as a gooseneck hose.

According to a preferred embodiment of the present invention, at least a joining member is provided to cooperate with the wrap corner to joining a plurality of the light source devices, wherein each of the wrap corners has an engaging hole, wherein each of the joining members comprises an engaging unit corresponding to each corresponding engaging hole, wherein the engaging unit cooperates with the engaging hole to join the adjacent light source devices together.

According to a preferred embodiment of the present invention, the set light fixture further comprises at least an engaging element arranged between the adjustment supporting device and the light source device for quick dismounting and installing the light source device from the adjustment supporting device.

According to a preferred embodiment of the present invention, the engaging elements are embodied as Velcro members, which are respectively arranged at a back surface of the light source device and the handle of the adjustment supporting device, so that the light source device is simply attached to or detached from the handle by attachment or detachment of the Velcro members.

According to a preferred embodiment of the present invention, the light source device is embodied as a monochromatic LED flexible light board.

According to a preferred embodiment of the present invention, the light source device is embodied as a dichromatic LED flexible light board.

According to a preferred embodiment of the present invention, the set light fixture further comprises an adapter device detachably fixed to the adjustment supporting device.

According to a preferred embodiment of the present invention, the adjustment supporting device comprises a handle, a holder and an adjustment screw, wherein the light source device is arranged at the adapter device, wherein the adapter device is detachably fixed to the handle, wherein the handle is rotatably mounted to the holder to define an angle relative to the holder, the adjustment screw is arranged for fixation.

According to a preferred embodiment of the present invention, the adapter device comprises at least an adapter plate, wherein the adapter plate has a plurality of threaded holes of different gauges to adapt a plurality of mounting positions and outer connectors.

According to a preferred embodiment of the present invention, the adapter device comprises at least a rotation device arranged at the adapter plate to rotatably connect the adapter plate with the light source device.

According to a preferred embodiment of the present invention, the adapter device comprises a plurality of magnetic units embedded in a side of the adapter plate adjacent to the adjustment supporting device.

According to a preferred embodiment of the present invention, the set light fixture further comprises a protective film which is covered on a region of the adapter plate which is embedded with the magnetic units of the adapter plate to protect the magnetic units.

According to a preferred embodiment of the present invention, the rotation device comprises a pressing plate, a screw, a nut, and a rotation member, wherein the screw is fixed to the adapter plate by the pressing plate, wherein the rotating element, which passes through the screw, is retained in position via the nut, and is coupled to the light source device.

According to a preferred embodiment of the present invention, the light source device is implemented as an LED box lamp comprising a bottom case, a plurality of LED illumination members, a light filter, and two visors, wherein the plurality of LED illumination members are arranged at the bottom case, and the light filter cover is disposed on the plurality of LED illumination members, wherein the two visors are respectively arranged at both sides of the LED illumination members and the light filter for adjusting an angle and a scope of light.

According to a preferred embodiment of the present invention, the bottom case has a receiving groove having an opening, wherein a plurality of heat dissipation fins are provided on a side edge of the receiving groove, wherein two sliding grooves are provided adjacent to the opening of the receiving groove to receive the light filter.

According to a preferred embodiment of the present invention, the light source device comprises a locker member, wherein when two side of the light filter are respectively arranged at the sliding groove, the locker member fastens the light filter to the bottom case.

According to a preferred embodiment of the present invention, the light source device further comprises two sets of movable members, wherein the movable members respectively arranges the two visors at the bottom case, wherein each set of the movable members comprises a rotation shaft and a plurality of rotation fixing members, wherein each of the visors is fixed to the rotation fixing members, and each of the rotation fixing member is movably mounted at the rotation shaft, wherein the visors rotate with respect to the rotation shaft towards the bottom case by the rotation fixing members, so as to adjust an angel and a height of light.

According to a preferred embodiment of the present invention, the visor further comprises a plurality of clamps arranged at an edge thereof for gripping a light filter fabric.

According to a preferred embodiment of the present invention, the light source device is embodied as an LED zoom lamp comprising a heat sink casing and a plurality of LED zoom spotlights, wherein a plurality of the LED zoom spotlights are respectively arranged at the heat sink casing.

According to a preferred embodiment of the present invention, the heat sink casing comprises an upper housing having a plurality of placing holes for receiving the LED zoom spotlights.

According to a preferred embodiment of the present invention, the heat sink casing comprises a lower housing, wherein the lower housing has a plurality of sets of heat dissipation holes, wherein when the upper housing is connected to the lower housing, each set of the heat dissipation holes is relatively aligned with the placing holes to discharge thermal energy generated by the LED zoom spotlights.

According to a preferred embodiment of the present invention, the heat sink casing comprises a plurality of fans, a plurality of locking covers, a plurality of rubber rings, and a plurality of gaskets, wherein a plurality of the fans are corresponding to each set of the g heat dissipation holes, and is fixed to the lower housing, wherein each of the locking covers is respectively locked to the placing hole of the upper housing, and press-fits and locks the gasket and the rubber ring respectively to the placing hole of the upper housing to achieve a waterproof and shockproof function.

According to a preferred embodiment of the present invention, each of the LED zoom spotlights comprises a supporting base, at least an LED illumination member, and a light cover, wherein the LED illumination member is arranged at the supporting base, wherein the light cover is arranged above the LED illumination member.

According to a preferred embodiment of the present invention, each of the LED zoom spotlights comprises a ball head member arranged at a bottom of the supporting base, wherein when the ball head member is coupled with the heat sink casing, the LED zoom spotlight is rotated to adjust an angle within a predetermined range.

According to a preferred embodiment of the present invention, each of the LED zoom spotlights comprises an adjusting ring and a telescopic adjusting element, wherein the telescopic adjusting element with the adjusting ring is disposed at the supporting base, so that the telescopic adjusting element is capable of being moved up and down relative to the supporting base to change a focal length of the LED light.

According to a preferred embodiment of the present invention, the light cover is embodied as a zoom lens.

According to a preferred embodiment of the present invention, the light cover is embodied as a Fresnel zoom lens having a characteristic that an edge of a bright spot is blurred.

According to a preferred embodiment of the present invention, the light source device is embodied as an LED flag board light comprising a bottom plate, a plurality of LED illumination members, a protective film, and a plurality of attaching members, wherein a plurality of the LED illumination members is arranged in an array arrangement at the bottom plate, wherein the protective film is covered on the plurality of the LED illumination members by a vacuum molding process, wherein the plurality of the attaching members are disposed at edges of the front and back surfaces of the bottom plate to realize simple joining, so that the light source devices are combined to provide a relatively large illumination range.

According to a preferred embodiment of the present invention, the LED flag board light adopts a waterproof fabric.

According to a preferred embodiment of the present invention, the attaching members are embodied as Velcro members, wherein the Velcro members are respectively provided at edges of the front and back sides of the bottom plate to join a plurality of the light source devices.

According to a preferred embodiment of the present invention, the set light fixture further comprises a supporting set which comprises an upper rod, a lower rod, two side rods, and a connecting rod, wherein the light source device is fixed to the upper rod and the lower rod, wherein the two side rods are disposed at two ends of the upper rod and the lower rod, wherein the connecting rod is arranged in a middle of the lower rod to adapt to insert into various slots or holes.

According to a preferred embodiment of the present invention, each of the side rods is embodied as a flexible telescopic rod.

According to a preferred embodiment of the present invention, the handle comprises a supporting portion, at least two clamping members and at least two fixing members, wherein the light source device is arranged at the supporting portion, wherein the light source device is clamped by the clamping members, wherein the light source device is fixed to the supporting portion by the fixing members connected to the clamping members.

According to a preferred embodiment of the present invention, the handle comprises a supporting portion and at least two fixing members, wherein the light source device is arranged at the supporting portion by the adapter device and is fixed by the fixing members.

According to a preferred embodiment of the present invention, the holder comprises a body portion and a locking member, wherein the body portion has a hollow groove and a wall hole penetrating through a sidewall of the hollow groove, wherein when the holder is arranged at an article having a rod-shaped end by the hollow groove, the locking member passes through the wall hole to fix the holder to the rod-shaped end.

According to a preferred embodiment of the present invention, the handle comprises a first adjusting portion partially extended from the supporting portion and having an arc shape at a distal end, wherein a notch is formed at a non-extending portion of the first adjusting portion, wherein the holder comprises a second adjusting portion that is partially extended from the body portion of the holder and has an arc shape at a distal end, wherein a notch is formed at a non-extending portion of the second adjusting portion, wherein when the handle is disposed at the holder, the first adjusting portion is located at the notch of the non-extending portion of the second adjusting portion, and the second adjusting portion is located at the notch of the non-extending portion of the first adjusting portion.

According to a preferred embodiment of the present invention, wherein the first adjusting portion is provided with a first angle adjustment gear at a vertical plane of the first adjusting portion, wherein the second adjusting portion is provided with a second angle adjustment gear at a vertical surface of the second adjusting portion, wherein the first angle adjustment gear is engaged with the second angle adjustment gear to adjust a relative angle between the handle and the holder, wherein the relative angle is ensured via the adjustment screw.

According to a preferred embodiment of the present invention, the first adjusting portion of the handle has a first adjusting hole located at a center of the first angle adjusting gear, wherein the second adjusting portion of the holder has a second adjusting hole located at a center of the second angle adjustment gear, wherein when the first angle adjustment gear is engaged with the second angle adjustment gear, the first adjusting hole is aligned with the second adjusting hole, and the adjustment screw penetrates the first adjusting hole and the second adjusting hole to lock and fix the relative angle between the handle and the hand hole.

According to a preferred embodiment of the present invention, the supporting portion of the handle has at least two through holes, and a plurality of grooves, wherein the two through holes are respectively located at the head and tail ends of the supporting portion in cooperation with the fixing members to fix the light source device to the supporting portion of the handle, wherein the plurality of grooves are recessed from a surface of the supporting portion for heat dissipation and reducing a weight of the handle.

According to a preferred embodiment of the present invention, the light control driver comprises a driver body, at least an adjustment member and a protective cover, wherein the adjustment member is disposed at the driver body, wherein the adjustment member is disposed at an edge of the driver body and is protruded therefrom for convenient operation, wherein the protective cover has a convex structure to protect the adjustment member when the protective cover and the adjusting component are disposed at the driver body.

According to a preferred embodiment of the present invention, the light source device further comprises a power signal line and a wire fixer, wherein the wire fixer fixes the power signal line to the light source device.

According to a preferred embodiment of the present invention, the light source device further comprises a power signal line which connects the light source device with the light control driver.

According to a preferred embodiment of the present invention, the battery holder is disposed at the handle of the adjustment supporting device, and the battery holder and the light control driver are arranged at the handle side-by-side.

According to a preferred embodiment of the present invention, the battery holder is disposed at the light control driver.

In order to achieve one of the above objects, the present invention provides an application method of a set light fixture comprising the following steps.

(A) Arrange a light source device at an adapter device.

(B) Detachably mount the adapter device to an adjustment supporting device.

(C) Change an angle of the light source device by adjusting a handle, a holder and an adjustment screw.

(D) Electrically connect a portable power device to a light control driver to operate the light source device.

According to a preferred embodiment of the application method of the present invention, in the step (A), the adapter device comprises a plurality of magnetic units, so that the light source device is capable of attaching to a surface of any object that can be magnetically attracted by the magnetic units of the adapter device.

According to a preferred embodiment of the application method of the present invention, in the step (A), the light source device is embodied as an LED box lamp.

According to a preferred embodiment of the application method of the present invention, in the step (A), the light source device is embodied as an LED zoom lamp.

According to a preferred embodiment of the application method of the present invention, in the step (A), the light source device comprises two visors, wherein each of the visors includes a plurality of clamps disposed at edges thereof for clamping a light filter fabric.

According to a preferred embodiment of the application method of the present invention, the light source device comprises two sets of movable members which movably mount the two visors at two opposite sides of the light source device.

According to a preferred embodiment of the application method of the present invention, the light source device further comprises a power signal line which connects the light source device with the light control driver.

According to a preferred embodiment of the application method of the present invention, in the step (B), the adapter device comprises an adapter plate having a plurality of common threaded holes for rapidly locking or dismounting the light source device from the adapter plate.

According to a preferred embodiment of the application method of the present invention, in the step (B), the adapter device comprises a rotation device, such that the light source device is rotatable relative to the adjustment supporting device.

According to a preferred embodiment of the application method of the present invention, in the step (C), the first adjusting portion of the handle is provided with a first angle adjustment gear, and the second adjusting portion of the holder is provided with a second angle adjustment gear, wherein the first angle adjustment gear is engaged with the second angle adjustment gear and is locked or relaxed by the adjusting screw.

According to a preferred embodiment of the application method of the present invention, in the step (C), when the first angle adjustment gear is not tightly engaged with the second angle adjustment gear, the handle rotated relatively to the holder to change the angle of the light source device relative to the adjustment supporting device and is locked by the adjustment screw after adjustment.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a set light fixture according to a first preferred embodiment of the present invention, in which a light source device is implemented as a monochrome LED flexible light board.

FIG. 2 is a front perspective view of the set light fixture according to the first preferred embodiment of the present invention.

FIG. 3 is a rear perspective view of the set light fixture according to the first preferred embodiment of the present invention.

FIG. 4 is a side perspective view of the set light fixture according to the first preferred embodiment of the present invention.

FIG. 5 is a perspective view of the set light fixture according to the first preferred embodiment of the present invention, which is arranged without the light source device. In other words, this is the perspective view illustrating that a light control driver and a portable power device are arranged at an adjustment supporting device and the light source device can be disassembled from the adjustment supporting device.

FIG. 6 is an exploded view of the set light fixture according to the first preferred embodiment of the present invention, which illustrates that relationship of components of the adjustment supporting device.

FIG. 7 is a front perspective view of a set light fixture according to a second preferred embodiment of the present invention, in which a light source device is implemented as a dichromatic LED flexible light board.

FIG. 8 is a rear perspective view of the set light fixture according to the second preferred embodiment of the present invention.

FIG. 9A is a perspective view of the set light fixture according to the second preferred embodiment of the present invention, which is arranged without the light source device. In other words, this is the perspective view illustrating that a light control driver and a portable power device are arranged at an adjustment supporting device and the light source device can be disassembled from the adjustment supporting device.

FIG. 9B is a perspective view from a different view different from the view of the FIG. 9A.

FIG. 10 is a front perspective view of the set light fixture according to the first and second preferred embodiments of the present invention, which illustrates a schematic view of an arrangement of multiple light source devices.

FIG. 11 is a perspective view of a set light fixture according to a third preferred embodiment of the present invention, in which a light source device is implemented as a LED box lamp.

FIG. 12 is a side perspective view of the set light fixture according to the third preferred embodiment of the present invention.

FIG. 13 is a rear perspective view of the set light fixture according to the third preferred embodiment of the present invention.

FIG. 14 is a front perspective view of the set light fixture according to the third preferred embodiment of the present invention.

FIG. 15 is a sectional view along line A-A of FIG. 14.

FIG. 16 is a perspective view of the set light fixture according to the third preferred embodiment of the present invention, which is arranged without the light source device. In other words, this is the perspective view illustrating that a light control driver and a portable power device are arranged at an adjustment supporting device and the light source device can be dismounted from the adjustment supporting device.

FIG. 17 is a perspective view of a set light fixture according to a fourth preferred embodiment of the present invention, in which a light source device is implemented as a zoom LED lamp.

FIG. 18 is a front perspective view of the set light fixture according to the fourth preferred embodiment of the present invention.

FIG. 19 is a sectional view along line B-B of FIG. 18.

FIG. 20 is a rear perspective view of the set light fixture according to the fourth preferred embodiment of the present invention.

FIG. 21 is a perspective view of a set light fixture according to a fifth preferred embodiment of the present invention, in which a light source device is implemented as a LED flag-board lamp.

FIG. 22 is a rear perspective view of the set light fixture according to the fifth preferred embodiment of the present invention.

FIG. 23 is a perspective view of the set light fixture according to the fifth preferred embodiment of the present invention, which illustrates an arrangement of the multiple light source devices.

FIG. 24 is a schematic view of a battery holder of a portable power device of the set light fixture, which is suitable for a battery power supply of an existing U-type camera.

FIG. 25 is a schematic view of a battery holder of a portable power device of the set light fixture, which is suitable for a battery power supply of an existing V-type camera.

FIG. 26 is a schematic view of a battery holder of a portable power device of the set light fixture, which is suitable for a battery power supply of an existing V-type camera without a power interface.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

It should be understood by those skilled in the art that in the disclosure of the present invention, the terms like “longitudinal”, “transverse”, “upper”, “lower”, “front”, “back”, “left”, “right”, “upright”, “horizontal”, “top”, “bottom”, “inside”, and “outside”, etc. which indicates the orientation or positional relationship, is based on the orientation or positional relationship shown in the drawings, which is merely for the convenience of describing the present invention. And the above description of the invention is not to be construed as a limitation of the invention.

It will be understood that the term “a” is understood to mean “at least one” or “one or more”. In other words, in one embodiment, the number of an element may be one, and in other embodiments, the number of the element can be multiple. And the term “a” cannot be construed as a limitation on the quantity.

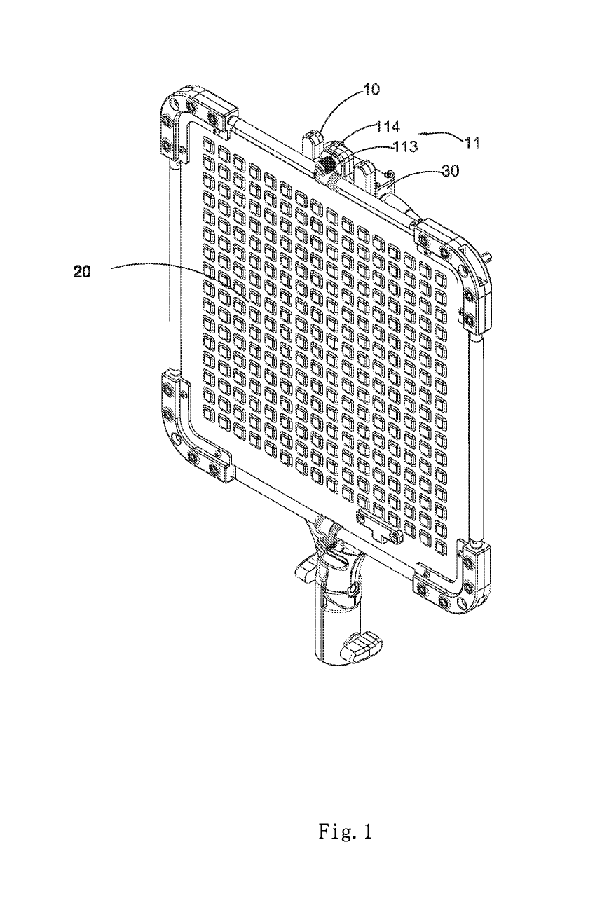

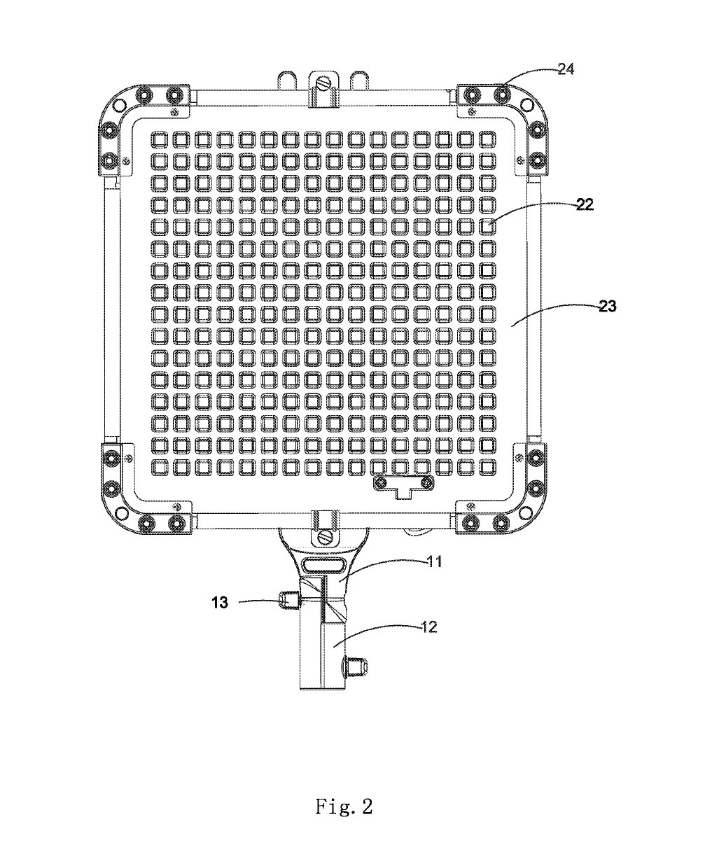

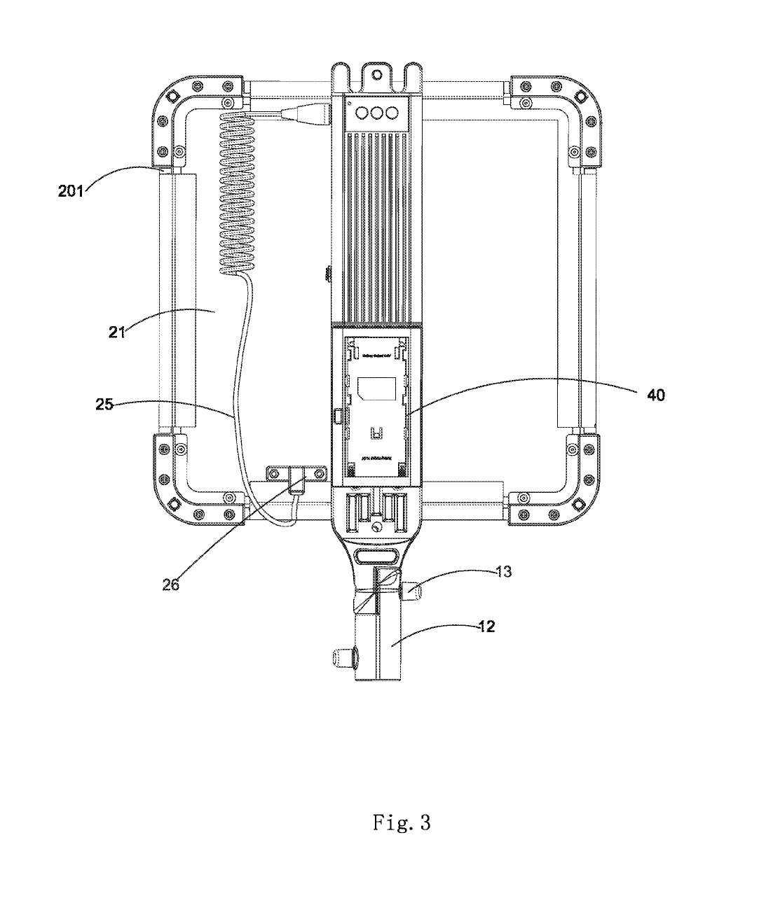

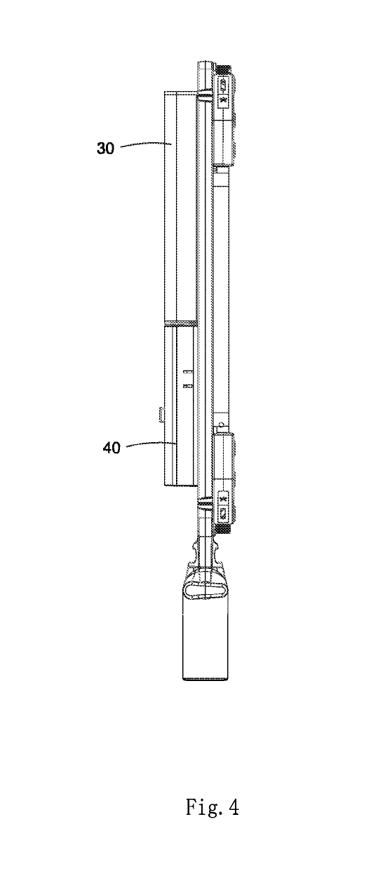

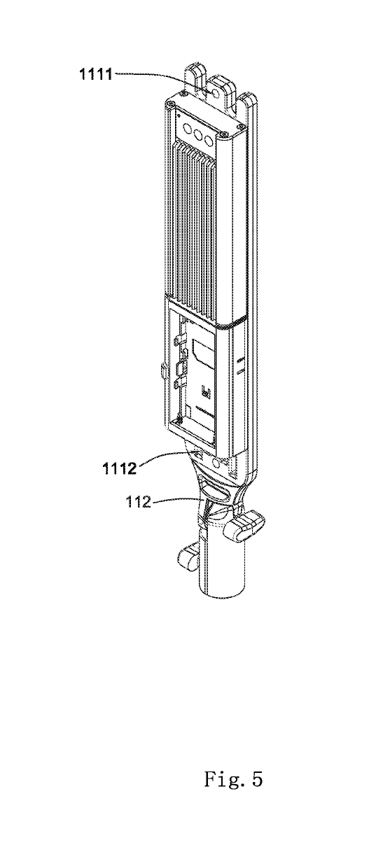

Referring to the FIG. 1 to FIG. 6, a set light fixture according to a first preferred embodiment of the present invention is illustrated, which can be conveniently applicable to various occasions requiring illumination or special light sources, particularly suitable for use in various photographing or imaging environments.

In accordance with this preferred embodiment of the present invention, the set light fixture comprises an adjustment supporting device 10, at least a light source device 20, a light control driver 30, and a portable power device 40. The adjustment supporting device 10 can support at least one of the light source devices 20 in a manner that an illumination angle and an illumination height of the light source device 20 are adjustable. Further, the light source device 20 is detachably mounted at the adjustment supporting device 10. The light control driver 30 is provided at the adjustment supporting device 10 and electrically connected to the light source device 20, so as to control various functions of the light source device 20. The portable power device 40 is arranged at the adjustment supporting device 10 and electrically connected to the light control driver 30 to provide power to the light source device 20. In this way, different types of the light source device 20 can be mounted at the adjustment supporting device 10 according to different needs in indoor photographing or outdoor photographing. The light source device 20 can be controlled to achieve various light patterns by adjusting the position and angle of the light source device 20 via the adjustment supporting device 10, and by providing power to actuate the light control driver 30 via the portable power device 40. Therefore, the present invention is easily applied to various complicated and varied photographing or imaging environments. In addition, the light control driver 30 and the portable power device 40 are arranged at the adjustment supporting device 10 side-by-side, so as to reduce a thickness of the set light fixture. In addition, it is worth mentioning that when the light source device 20, the light control driver 30 and the portable power device 40 are arranged at the adjustment supporting device 10, the connection may be locked by a plurality of connection devices, wherein the connection device can be implemented as a fastening mechanism in which a screw fitting with a screw hole or a nut is employed, but this is not a limitation of the present invention. In other words, it can also be implemented as a hook engaging with a hook slot or other engaging manners.

According to this preferred embodiment of the invention, the adjustment supporting device 10 comprises a handle 11, a holder 12 and an adjustment screw 13. The light source device 20 is arranged at the handle 11. The handle 11 is rotatably mounted at the holder 12. Therefore, the light source device 20 can be rotated relative to the holder 12 to adjust the illumination angle. The adjustment screw 13 is connected to the handle 11 and the holder 12 for fixing the handle 11 after the handle 11 is adjusted to define an angle relative to the holder 12. In other words, when the light source device 20 is initially arranged at the handle 11, the handle 11 and the holder 12 are in a released state. And then after the handle 11 and the holder 12 are adjusted to define a certain angle, the handle 11 is fixed to the holder 12 at the certain angle by the adjustment screw 13, so that the angle of the light source device 20 relative to the holder 12 is determined at the same time.

According to this preferred embodiment of the present invention, the handle 11 of the adjustment supporting device 10 comprises a supporting portion 111, a first adjusting portion 112, at least two clamping members 113 and at least two fixing members 114. The light source device 20 is arranged at the supporting portion 111, and is supported by the clamping elements 113 which are respectively fixed to the supporting portion 111 by the corresponding fixing members 114. The first adjusting portion 112 is provided with a first angle adjustment gear 1121. The first adjusting portion 112 is extended from a partial portion of the supporting portion 111, and has an arc shape at a distal end. In addition, when the first adjusting portion 112 is partially extended from the supporting portion 111, a notch is formed corresponding to a non-extending portion of the supporting portion 111, and it may be a 90-degree notch. That is to say, when the first adjusting portion 112 is partially extended from the supporting portion 111, a plane and a vertical surface intersecting the plane are simultaneously formed. When the notch is 90 degrees, the plane is a horizontal plane. The first angle adjustment gear 1121 is formed at the first adjusting portion 112. Further, the first angle adjustment gear 1121 is formed at the vertical plane of the first adjusting portion 112.

According to the preferred embodiment of the invention, the holder 12 of the adjustment supporting device 10 comprises a body portion 121, a second adjusting portion 122 and a locking member 123. The body portion 121 has a hollow structure. That is to say, the body portion 121 of the holder 12 has a hollow groove. In addition, the body portion 121 of the holder 12 further has a wall hole 1211 penetrating through a side wall around the hollow groove, such that the holder 12 of the adjustment supporting device 10 can be locked with a rod-shaped end with a certain thickness in the hollow groove so as to arrange the holder 12 at an article having the rod-shaped end. In other words, when the hollow groove of the body portion 121 of the holder 12 is engaged with the rod-shaped end of the article, the holder 12 is fixed to the article having the rod-shaped end by the locking member 123 passing through the wall hole 1211, so that the height of the handle 11 connected to the holder 12 can be further adjusted, that is to say, the height of the light source device 20 can be adjusted. It is worth mentioning that the article having the rod-shaped end can be implemented as a tripod, so that the set light fixture of the present invention can be arranged anywhere to adjust the height and angle according to the requirements of the shooting circumstances, so as to provide desired illumination and light patterns. Further, the second adjusting portion 122 partially extending from the body portion 121 of the holder 12 has an arc shape at the distal end thereof. In addition, when the second adjusting portion 122 is partially extended from the body portion 121, a notch, which may be a 90-degree notch, is formed corresponding to the non-extending portion. That is to say, when the second adjusting portion 122 is partially extended from the body portion 121, a plane and a vertical surface intersecting the plane are simultaneously formed. When the notch has an angel of 90 degrees, the plane is a horizontal plane. A second angle adjustment gear 1221 is formed at the second adjusting portion 122. Further, the second angle adjustment gear 1221 is formed at the vertical surface of the second adjusting portion 122. It can be understood that when the handle 11 is arranged at the holder 12, the first adjusting portion 112 is located at the notch of the second adjusting portion 122, and the second adjusting portion 122 is located at the notch of the first adjusting portion 112, and the first angle adjustment gear 1121 will be engaged with the second angle adjustment gear 1221 for adjusting the relative angle between the handle 11 and the holder 12, and the relative angle is locked and fixed by the adjustment screw 13. Therefore, it can be understood that the first adjusting portion 112 of the handle 11 has a first adjusting hole 1122 located at a center of the first angle adjustment gear 1121. The second adjusting portion 122 of the holder 12 has a second adjusting hole 1222 located at a center of the second angle adjustment gear 1221, when the first angle adjustment gear 1121 is engaged with the second angle adjustment gear 1221, the first adjusting hole 1122 is aligned with the second adjusting hole 1222, such that the adjustment screw 13 will penetrate the first adjusting hole 1122 and the second adjusting hole 1222 to lock and fix the relative angle between the handle 11 and the holder 12.

According to this preferred embodiment of the present invention, the supporting portion 111 of the handle 11 has at least two through holes 1111, and a plurality of grooves 1112, in which the two through holes 1111 are respectively located at the head and tail ends of the supporting portion 111. The plurality of grooves 1112 are recessed from the surface of the supporting portion 111, and are located at an opposite side of the light source device 20. That is to say, when the light source device 20 is arranged at the supporting portion 111 of the handle 11, the clamping members 113 support the light source device 20 at the head and the tail ends of the light source device 20, and the fixing members 114 pass through the corresponding clamping member 113 and the two through holes 1111 of the supporting portion 111 to fix the light source device 20 to the supporting portion 111 of the handle 11. At this time, the plurality of grooves 1112 is formed at the supporting portion 111 and is located at the opposite side of the light source device 20 for dissipating heat and reducing the weight of the handle 11. In other words, the plurality of grooves 1112 forms a heat dissipation structure of the light source device 20. Those skilled in the art will appreciate that the grooves 1112 facilitates heat dissipation and reduces mass, but does not constitute a limitation of the handle 11, the handle 11 having a plane structure does not affect the implementation of the present invention.

According to this preferred embodiment of the present invention, the set light fixture further comprises at least one engaging element arranged between the adjustment supporting device 10 and the light source device 20 for quick disassembly and installation of the light source device 20 to the adjustment supporting device 10. The engaging elements are embodied as Velcro members, which are respectively arranged at a back surface of the light source device 20 and the supporting portion 111 of the handle 11 of the adjustment supporting device 10, such that the light source device 20 can be simply attached to or detached from the handle 11 by the attachment or separation of the Velcro members.

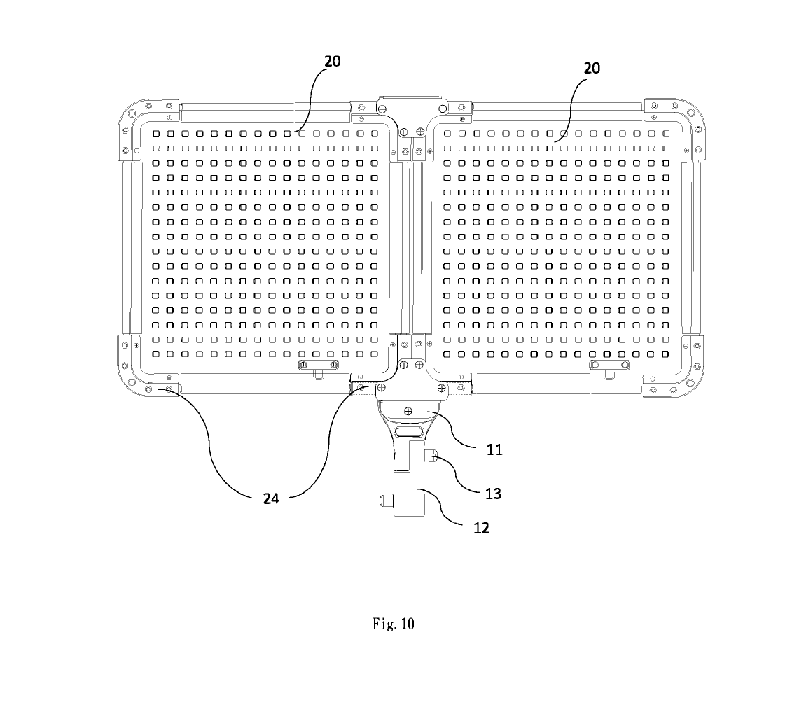

According to this preferred embodiment of the present invention, the light source device 20 comprises a bottom plate 21, a plurality of LED illumination members 22, a protective film 23, and a plurality of wrap corners 24. The bottom plate 21 is made of a flexible material, or can also be made of a fabric material. The plurality of the LED illumination members 22 are arranged at the bottom plate 21 in an array arrangement. The protective film 23 is covered on the plurality of the LED illumination members 22 by a vacuum molding process to provide a waterproof and moisture-proof protection function. The uniformity of protective film 23 at the bottom plate 21 is not affected while the bottom plate 21 is bended because of the vacuum molding process, thereby keeping the uniformity of the light emitted by the LED illumination members 22 from being affected by the bending of the bottom plate 21. The plurality of the wrap corners 24 are respectively arranged at respective corner positions of the bottom plate 21 to provide protection for the bottom plate 21. In addition, as shown in FIG. 10, the wrap corners 24 can also be coupled with joining members to join the bottom plate 21 with a bottom plate 21 of another light source devices 20 to provide a larger illumination range. In addition, it is worth mentioning that the light source device 20 can be implemented as a monochrome LED flexible light board. Therefore, the wrap corners 24 are capable of joining a plurality of the monochrome LED flexible light boards together through the joining members. Further, each of the wrap corners 24 has an engaging hole. And each of the joining members has an engaging units corresponding to the engaging holes to engage the adjacent monochrome LED flexible light boards together. Each of the engaging units may be implemented as a protruding hook device to be directly engaged with the engaging holes or the connection between the adjacent monochrome LED flexible light boards can be embodied as a fastening manner by engagement between a screw and a screw hole or engagement between a screw and a nut, which is not a limitation of the present invention.

According to this preferred embodiment of the present invention, the light source device 20 further comprises a power signal line 25 and a wire fixer 26 which fixes the power signal line 25 to the bottom plate 21 of the light source device 20. In addition, the light source device 20 may further comprise a plurality of supporting rods arranged around the bottom plate 21 to increase the strength of the monochrome LED flexible light board, and at the same time, when the monochrome LED flexible light board, that is the light source device 20, is arranged at the supporting portion 111 of the handle 11, the clamping elements 113, which provide support to the supporting rods, are fixed by the fixing members 114 to increase the stability of the light source device 20 arranged at the handle 11. In addition, the light source device 20 further comprises a plurality of supporting frames 201 arranged between the two wrap corners 24 respectively. According to the embodiment, for one of light source device 20, the number of the supporting frames 201 may be 4, and the number of the wrap corners 24 is also 4. Therefore, the one monochrome LED flexible light board has four supporting frames 201 and four wrap corners 24. The supporting frames 201 are arranged for supporting the bottom plate 21. Further, each of the support frames 201 is a gooseneck hose, like a metal hose of a microphone, for configuration.

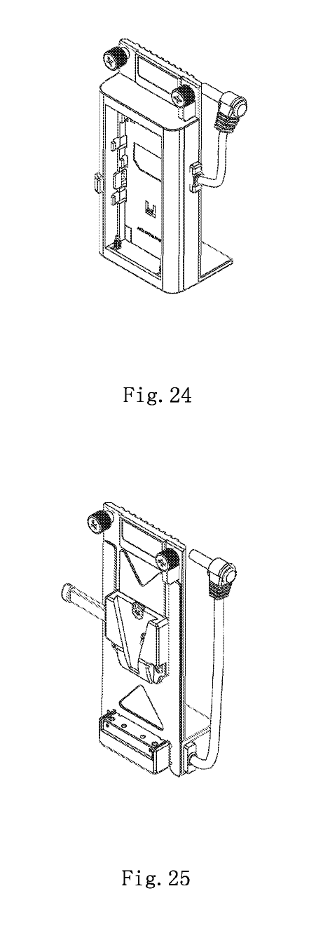

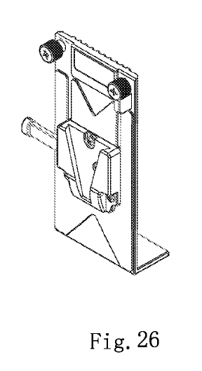

According to this preferred embodiment of the invention, the portable power device 40 comprises a battery holder and at least a battery unit. The battery holder is arranged at the supporting portion 111 of the handle 11 of the adjustment supporting device 10. The battery unit is detachably mounted to the battery holder. It is worth mentioning that when applied to different cameras, the battery holders can also be of different types to be adapted to battery power sources of different types of cameras, such as a battery power source of a U-type camera, a battery power source of a V-type camera, and a battery power source of a V-type camera without an power interface, as shown in FIG. 24 to FIG. 26.

In addition, the present invention also provides a practical method for the set light fixture, comprising the following steps:

(a) detachably mounting the light source device 20 to the adjustment supporting device 10;

(b) changing the angle of the light source device 20 by adjusting the handle 11, the holder 12 and the adjustment screw 13; and

(c) electrically connecting the portable power device 40 to the light control driver 30 for operating the light source device 20.

According to the step (a), the light source device 20 can be embodied as a monochromatic LED flexible light board.

According to the step (a), the light source device 20 comprises a bottom plate 21 made of a flexible material.

According to the step (a), the light source device 20 comprises a plurality of LED illumination members 22 which is arranged at the bottom plate 21 in an array arrangement.

According to the step (a), the light source device 20 comprises a protective film 23 which is covered on the plurality of the LED illumination members 22 by a vacuum molding process to provide the waterproof and moisture-proof protection function.

According to the step (a), the light source device 20 comprises a plurality of wrap corners 24 respectively arranged at respective corner positions of the bottom plate 21 to protect the light source device 20 and or joining the plurality of light source devices 20.

According to step (a), the light source device 20 comprises at least a joining member that cooperates with the wrap corner 24 to achieve a combination of the light source devices 20, so as to provide a relatively large illumination range.

According to the step (a), at least an engaging element is arranged between the adjustment supporting device 10 and the light source device 20 for quick disassembly and installation of the light source device 20 to the adjustment supporting device 10.

According to the step (a), the engaging elements are implemented as Velcro members, which are respectively arranged at the back surface of the light source device 20 and the supporting portion 111 of the handle 11 of the adjustment supporting device 10, such that the light source device 20 can be simply attached to or detached from the handle 11 by the attachment or separation of the Velcro members.

According to the step (b), the first adjusting portion 112 of the handle 11 is provided with a first angle adjustment gear 1121, and the second adjusting portion 122 of the holder 12 is provided with a second angle adjustment gear 1221, wherein the first angle adjustment gear 1121 is engaged with the second angle adjustment gear 1221 and is locked or released by the adjustment screw 13.

According to the step (b), when the first angle adjustment gear 1121 and the second angle adjustment gear 1221 are not tightly engaged, the handle 11 can be relatively rotatable relative to the holder 12 to change the angle of the light source device 20 relative to the support device 10, and is locked by the adjustment screw 13 after adjustment.

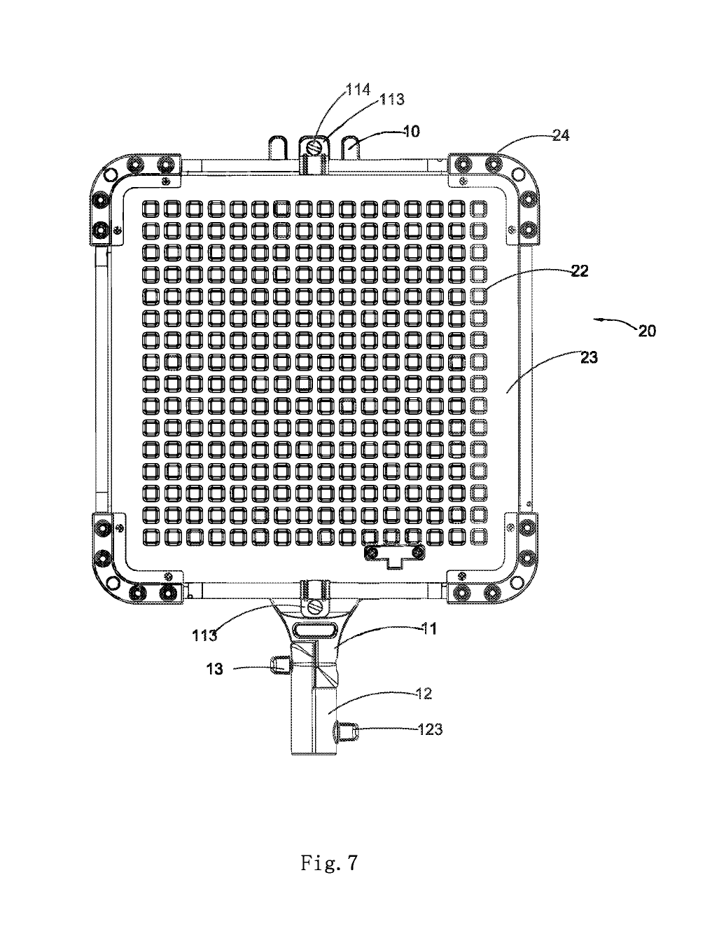

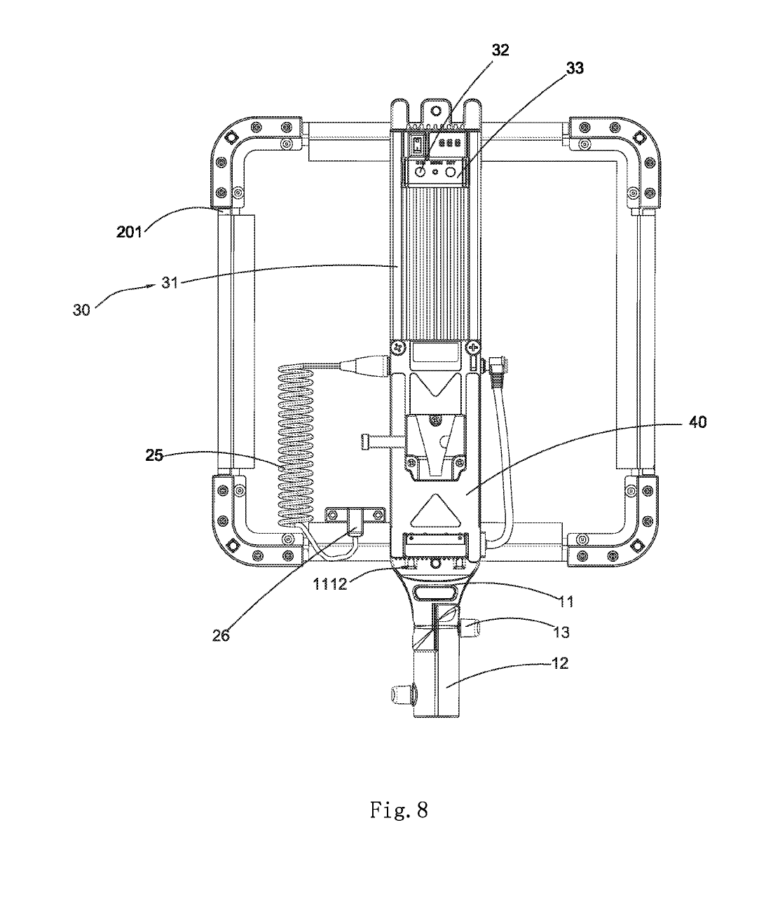

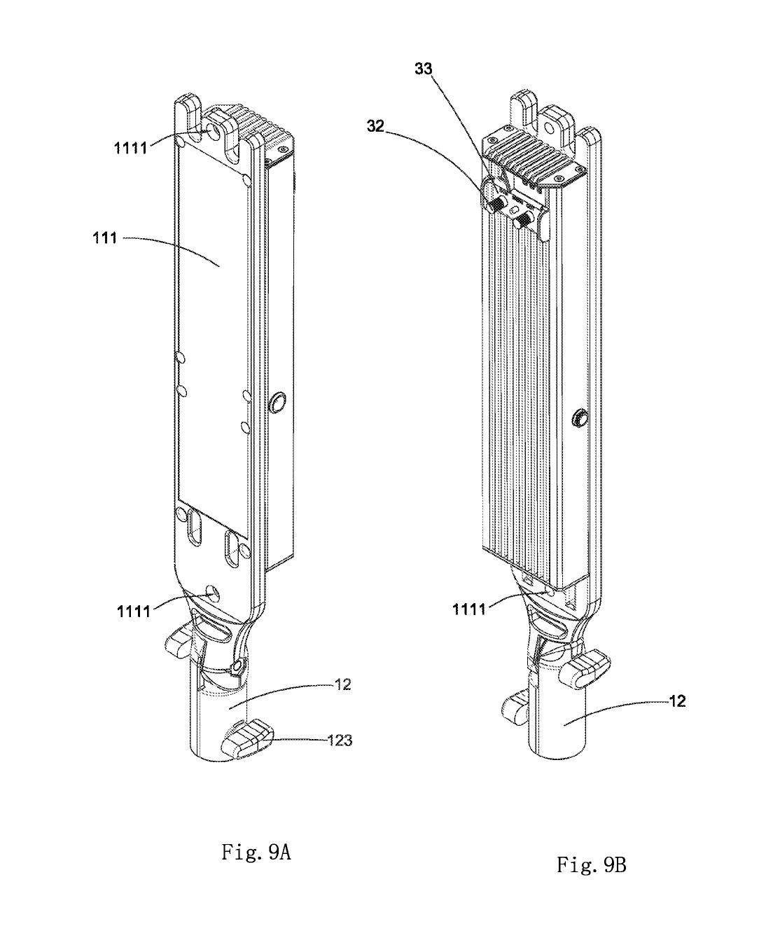

Referring to the FIG. 7 to FIG. 9B, a set light fixture according to a second preferred embodiment of the present invention is illustrated, the set light fixture can be conveniently applicable to various occasions requiring illumination or special light sources, particularly suitable for use in various photographing or imaging environments.

In accordance with this preferred embodiment of the present invention, the set light fixture comprises an adjustment supporting device 10, at least a light source device 20, a light control driver 30, and a portable power device 40. The adjustment supporting device 10 can support at least one of the light source devices 20 in a manner that an angle and a height are adjustable. Further, the light source device 20 is detachably mounted at the adjustment supporting device 10. The light control driver 30 is disposed at the adjustment supporting device 10 and electrically connected to the light source device 20, so as to control various functions of the light source device 20. The portable power device 40 is arranged at the adjustment supporting device 10 and electrically connected to the light control driver 30 to provide power to the light source device 20. In this way, different types of the light source device 20 can be mounted at the adjustment supporting device 10 according to different needs in indoor or outdoor photographing. The light source device 20 can be controlled to achieve various light patterns by adjusting the position and angle of the light source device 20 via the adjustment supporting device 10, and providing power to the light control driver 30 via the portable power device 40. Therefore, the present invention is easily applied to various complicated and varied photographing or imaging environments. In addition, the light source device 20 in the first embodiment of the present invention is implemented as a monochrome LED flexible light board, and the light source device 20 of the second embodiment of the present invention is implemented as a dichromatic LED flexible light board, in which the light control driver 30 of the second embodiment is relatively large in size, so the portable power device 40 will be arranged at the light control driver 30. In addition, it is worth mentioning that when the light source device 20, the light control driver 30 and the portable power device 40 are arranged at the adjustment supporting device 10, the connection may be locked by a plurality of connection devices, wherein the connection device can be implemented as a fastening mechanism in which a screw and a screw hole or the nut are fitted, but this is not a limitation of the present invention. In other words, it can also be implemented as other engagement manners such as an engagement of a hook and a slot.

According to this preferred embodiment of the invention, the adjustment supporting device 10 comprises a handle 11, a holder 12 and an adjustment screw 13.

The light source device 20 is arranged at the handle 11. The handle 11 is rotatably mounted at the holder 12. Therefore, the light source device 20 can be rotated relative to the holder 12 to adjust the angle. The adjustment screw 13 is connected to the handle 11 and the holder 12 for fixing the handle 11 after the handle 11 is adjusted to define an angle relative to the holder 12. In other words, when the light source device 20 is initially arranged at the handle 11, the handle 11 and the holder 12 are in a released state. And then after the handle 11 and the holder 12 are adjusted to define at a certain angle, the handle 11 is fixed to the holder 12 at the certain angle by the adjustment screw 13. So, the angle of the light source device 20 relative to the holder 12 is determined at the same time.

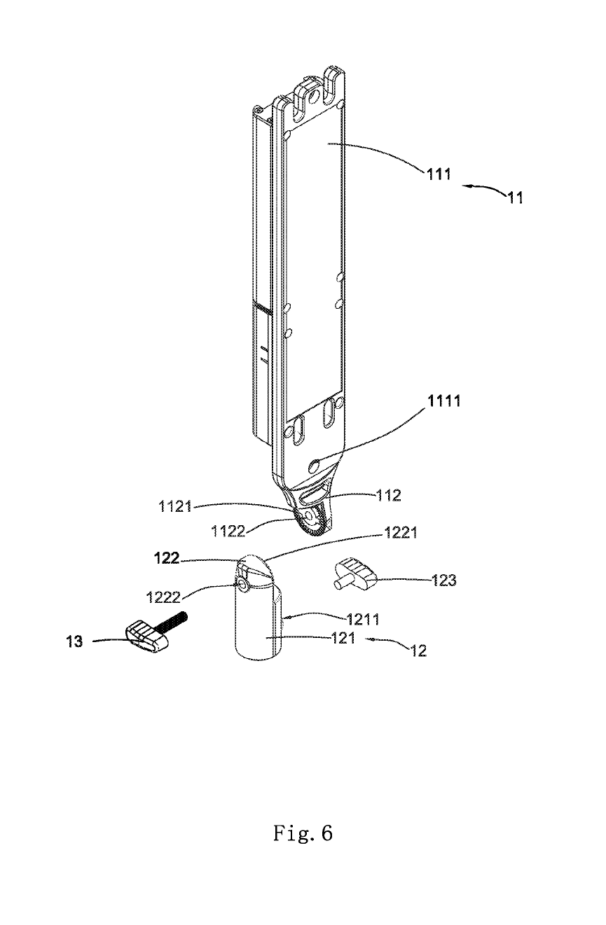

According to this preferred embodiment of the present invention, the handle 11 comprises a supporting portion 111, a first adjusting portion 112, at least two clamping members 113 and at least two fixing members 114. The light source device 20 is arranged at the supporting portion 111, and supported by the clamping elements 113 which are respectively fixed to the supporting portion 111 by the fixing members 114. The first adjusting portion 112 is provided with a first angle adjustment gear 1121. The first adjusting portion 112 is partially extended from the supporting portion 111, and has an arc shape at a distal end. In addition, when the first adjusting portion 112 is partially extended from the supporting portion 111, a notch, which may be a 90-degree notch, is formed corresponding to a non-extending portion. That is to say, when the first adjusting portion 112 is partially extended from the supporting portion 111, a plane and a vertical surface intersecting the plane are simultaneously formed. When the notch is 90 degrees, the plane is a horizontal plane. The first angle adjustment gear 1121 is formed at the first adjusting portion 112. Further, the first angle adjustment gear 1121 is formed at the vertical plane of the first adjusting portion 112, as is similar to FIG. 6.

According to this preferred embodiment of the invention, the holder 12 comprises a body portion 121, a second adjusting portion 122 and a locking member 123. The body portion 121 has a hollow structure. That is to say, the body portion 121 of the holder 12 has a hollow groove. In addition, the body portion 121 of the holder 12 further has a wall hole 1211 penetrating through a side wall of the hollow groove, such that the holder 12 of the adjustment supporting device 10 can lock with a rod-shaped end of a certain thickness in the hollow groove so as to mount the holder 12 at an article having the rod-shaped end. In other words, when the hollow groove of the body portion 121 of the holder 12 is engaged with the rod-shaped end of the article, the holder 12 is fixed to the article having the rod-shaped end by the locking member 123 passing through the wall hole 1211, so that the height of the handle 11 connected to the holder 12 can be further adjusted, that is to say, the height of the light source device 20 can be adjusted. It is worth mentioning that the article having the rod-shaped end can be implemented as a tripod, so that the set light fixture of the present invention can be arranged anywhere to adjust the height and angle according to the requirements of the shooting circumstance to provide desired illumination and light patterns. Further, the second adjusting portion 122 is partially extended from the body portion 121 of the holder 12, and has an arc shape at the distal end. In addition, when the second adjusting portion 122 is partially extended from the body portion 121, a notch, which may be a 90-degree notch, is formed in the non-extending portion. That is to say, when the second adjusting portion 122 is partially extended from the body portion 121, a plane and a vertical surface intersecting the plane are simultaneously formed. When the notch is 90 degrees, the plane is a horizontal plane. The second adjusting portion 122 is formed with a second angle adjustment gear 1221. Further, the second angle adjustment gear 1221 is formed at the vertical surface of the second adjusting portion 122. It can be understood that when the handle 11 is arranged at the holder 12, the first adjusting portion 112 is located at the notch of the second adjusting portion 122, and the second adjusting portion 122 is located at the notch of the first adjusting portion 112, and the first angle adjustment gear 1121 will be engaged with the second angle adjustment gear 1221 for adjusting the relative angle of the handle 11 and the holder 12, and is locked and fixed by the adjustment screw 13. Therefore, it can be understood that the first adjusting portion 112 of the handle 11 has a first adjusting hole 1122 located at a center of the first angle adjustment gear 1121. The second adjusting portion 122 of the holder 12 has a second adjusting hole 1222 located at a center of the second angle adjustment gear 1221, in which when the first angle adjustment gear 1121 is engaged with the second angle adjusting the gear 1221, the first adjusting hole 1122 is aligned with the second adjusting hole 1222, such that the adjustment screw 13 will penetrate the first adjusting hole 1122 and the second adjusting hole 1222 to lock and fix the relative angle between the handle 11 and the holder 12, as is similar to FIG. 6.

According to this preferred embodiment of the present invention, the supporting portion 111 of the handle 11 has at least two through holes 1111, and a plurality of grooves 1112, in which the two through holes 1111 are respectively located at the head and tail ends of the supporting portion 111. The plurality of grooves 1112 is located at an opposite side of the light source device 20. That is to say, when the light source device 20 is arranged at the supporting portion 111 of the handle 11, the clamping members 113 support the light source device 20 at the head and the tail ends of the light source device 20, and the fixing members 114 pass through the clamping members 113 and the two through holes 1111 of the supporting portion 111 to fix the light source device 20 to the supporting portion 111 of the handle 11. At this time, the plurality of grooves 1112 are formed at the supporting portion 111 and are located at the opposite side of the light source device 20 for dissipating heat and reducing the weight of the handle 11. In other words, the plurality of grooves 1112 forms a heat dissipation structure of the light source device 20. Those skilled in the art will appreciate that the grooves 1112 facilitates heat dissipation and reduces mass, but does not constitute a limitation of the handle 11, the handle may be arranged to have a plane structure that does not affect the implementation of the present invention.

According to this preferred embodiment of the present invention, the set light fixture further comprises at least one engaging element arranged between the adjustment supporting device 10 and the light source device 20 for quick disassembly and installation of the light source device 20 to the adjustment supporting device 10. The engaging elements are implemented as Velcro members, which are respectively arranged at the back surface of the light source device 20 and the supporting portion 111 of the handle 11 of the adjustment supporting device 10, such that the light source device 20 can be simply attached to or detached from the handle 11 by the attachment or separation of the Velcro members.

According to this preferred embodiment of the present invention, the light source device 20 comprises a bottom plate 21, a plurality of LED illumination members 22, a protective film 23, and a plurality of wrap corners 24. The bottom plate 21 is made of a flexible material, or can also be made of a fabric material. The plurality of the LED illumination members 22 are arranged at the bottom plate 21 in an array arrangement. The protective film 23 is covered on the plurality of the LED illumination members 22 by a vacuum molding process to provide a waterproof and moisture-proof protection function. The uniformity of protective film 23 at the bottom plate 21 is not affected while the bottom plate 21 is bended because of the vacuum molding process, thereby keeping the uniformity of the light emitted by the LED illumination members 22 from being affected by the bending of the bottom plate 21. The plurality of the wrap corners 24 are respectively arranged at respective corner positions of the bottom plate 21 to provide protection for the bottom plate 21. In addition, each of the wrap corners 24 can also be joined with a joining member to join the bottom plate 21 with a bottom plate 21 of another light source devices 20 to provide a larger illumination range. In addition, it is worth mentioning that the light source device 20 can be implemented as a dichromatic LED flexible light board. Therefore, the wrap corners 24 are capable of joining a plurality of the dichromatic LED flexible lamp boards together through the joining members. Further, the wrap corners 24 have a plurality of engaging holes. And the joining members have a plurality of engaging units corresponding to the engaging holes to engage the adjacent dichromatic LED flexible lamp panels together. As is shown as FIG. 10, Each of the engaging units may be implemented as a protruding hook device to be directly engaged with the engaging hole or the engagement manner between the adjacent dichromatic LED flexible lamp panels can be embodied as a fastening manner of a screw engaging with a screw hole or a nut, which is not a limitation of the present invention

According to the preferred embodiment of the present invention, the light source device 20 further comprises a power signal line 25 and a wire fixer 26. The wire fixer 26 fixes the power signal line 25 to the bottom plate 21 of the light source device 20. In addition, the light source device 20 further comprises a plurality of supporting rods arranged around the bottom plate 21 to increase the strength of the dichromatic LED flexible light board, and at the same time, when the dichromatic LED flexible light board, that is the light source device 20 is arranged at the supporting portion 111 of the handle 11, the clamping elements 113, which provide support to the supporting rod, are respectively fixed by the fixing members 114 to increase the stability of the light source device 20 arranged at the handle 11. In addition, the light source device 20 further comprises a plurality of supporting frames 201 respectively arranged between the two wrap corners 24. According to the embodiment, for one of light source device 20, the number of the supporting frames 201 may be 4, and the number of the wrap corners 24 is also 4. Therefore, the one dichromatic LED flexible light board has four of the supporting frames 201 and four of the wrap corners 24. The supporting frames 201 are for supporting the bottom plate 21. Further, each of the supporting frame 201 can be a gooseneck hose, like a metal hose of a microphone, for configuration.

In accordance with the preferred embodiment of the present invention, the light control driver 30 comprises a driver body 31, at least an adjustment member 32 and a protective cover 33. The adjustment member 32 is arranged at the driver body 31, and is protrudedly arranged at an edge of the driver body 31 for easy operation, but is easily damaged by the collision during carrying. Therefore, the protective cover 33 with a convex structure is provided to cooperate with the adjusting member 32 to protect it. In addition, the adjustment member 32 can be implemented as at least one knob or at least one switch, such that the protective cover 33 having a convex structure couples with the knob or the switch to protect the knob or the switch. Further, the protective cover 33 has a heat dissipation structure designed at the same time.

According to this preferred embodiment of the invention, the portable power device 40 comprises a battery holder and at least a battery unit. The battery holder is arranged at the supporting portion 111 of the handle 11 of the adjustment supporting device 10. The battery unit is detachably mounted to the battery holder. It is worth mentioning that when applied to different cameras, the battery holders can also be of different types to be adapted to battery power sources of different types of cameras, such as the battery power source of the U-type camera, the battery power source of the V-type camera, and the battery power source of V-type camera without the power interface. That is to say, the present invention provides three types of battery holders for replacement in accordance with existing battery models to increase the utility of the kit of the present invention, as shown in FIG. 24 to FIG. 26.

In addition, the present invention also provides a practical method for the set light fixture, comprising the following steps:

(a) detachably mounting the light source device 20 to the adjustment supporting device 10;

(b) changing the angle of the light source device 20 by adjusting the handle 11, the holder 12 and the adjustment screw 13; and

(c) electrically connecting the portable power device 40 to the light control driver 30 to operate the light source device 20.

According to step (a), the light source device 20 is embodied as a dichromatic LED flexible light board.

According to the step (a), the light source device 20 comprises a bottom plate 21 made of a flexible material.

According to the step (a), the light source device 20 comprises a plurality of LED illumination members 22 which are arranged at the bottom plate 21 in an array arrangement.

According to the step (a), the light source device 20 comprises a protective film 23 which is covered on the plurality of the LED illumination members 22 by a vacuum molding process to provide the waterproof and moisture-proof protection function.

According to the step (a), the light source device 20 comprises a plurality of wrap corners 24 respectively arranged at respective corner positions of the bottom plate 21 to protect the light source device 20 and for joining the plurality of light source devices 20.

According to step (a), the light source device 20 comprises at least a splicing member that cooperates with the wrap corner 24 to provide a combination of the other of the light source devices 20, which can provide the larger illumination range.

According to the step (a), at least an engaging element is arranged between the adjustment supporting device 10 and the light source device 20 for quick disassembly and installation of the light source device 20 to the adjustment supporting device 10.

According to the step (a), the engaging elements are implemented as Velcro members, which are respectively arranged at the back surface of the light source device 20 and the supporting portion 111 of the handle 11 of the adjustment supporting device 10, such that the light source device 20 can be simply attached to or detached from the handle 11 by the attachment or separation of the Velcro members.

According to the step (b), the first adjusting portion 112 of the handle 11 comprises a first angle adjustment gear 1121, and the second adjusting portion 122 of the holder 12 comprises a second angle adjustment gear 1221, wherein the first angle adjustment gear 1121 is engaged with the second angle adjustment gear 1221 which is locked or released by the adjustment screw 13.

According to the step (b), when the first angle adjustment gear 1121 and the second angle adjustment gear 1221 are not tightly engaged, the handle 11 can be relatively rotatable relative to the holder 12 to change the angle of the light source device 20 relative to the support device 10, and is locked by the adjustment screw 13 after adjustment.

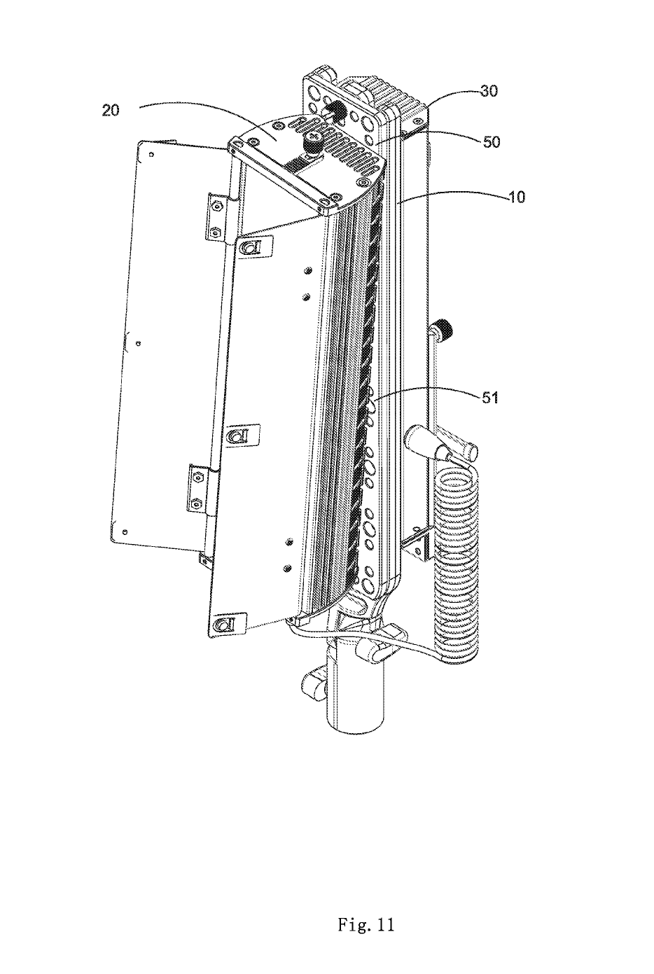

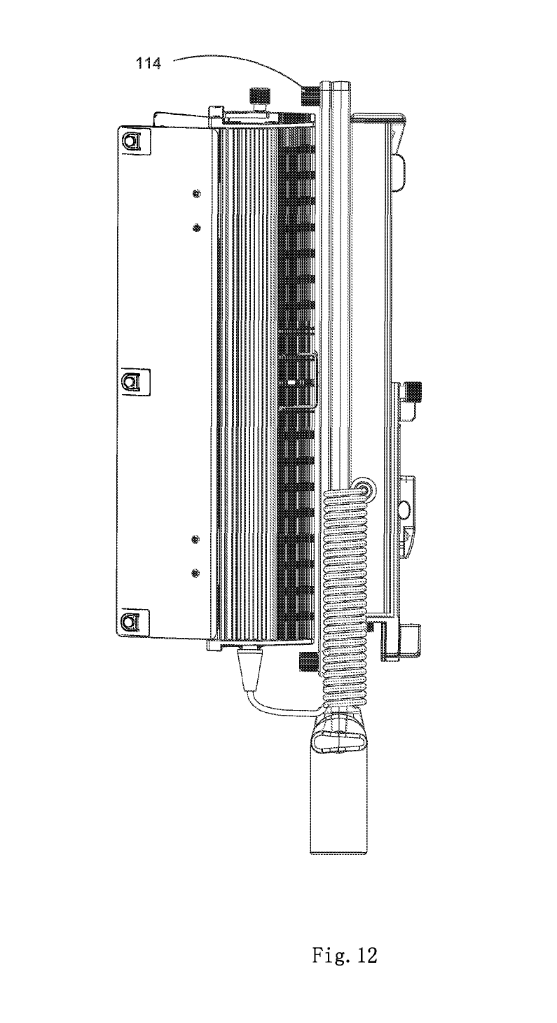

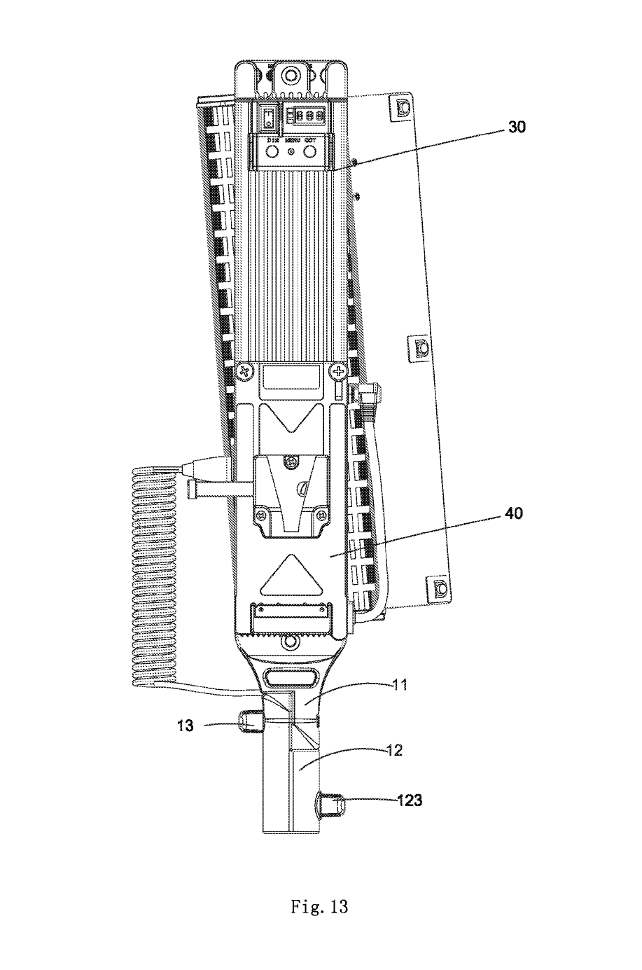

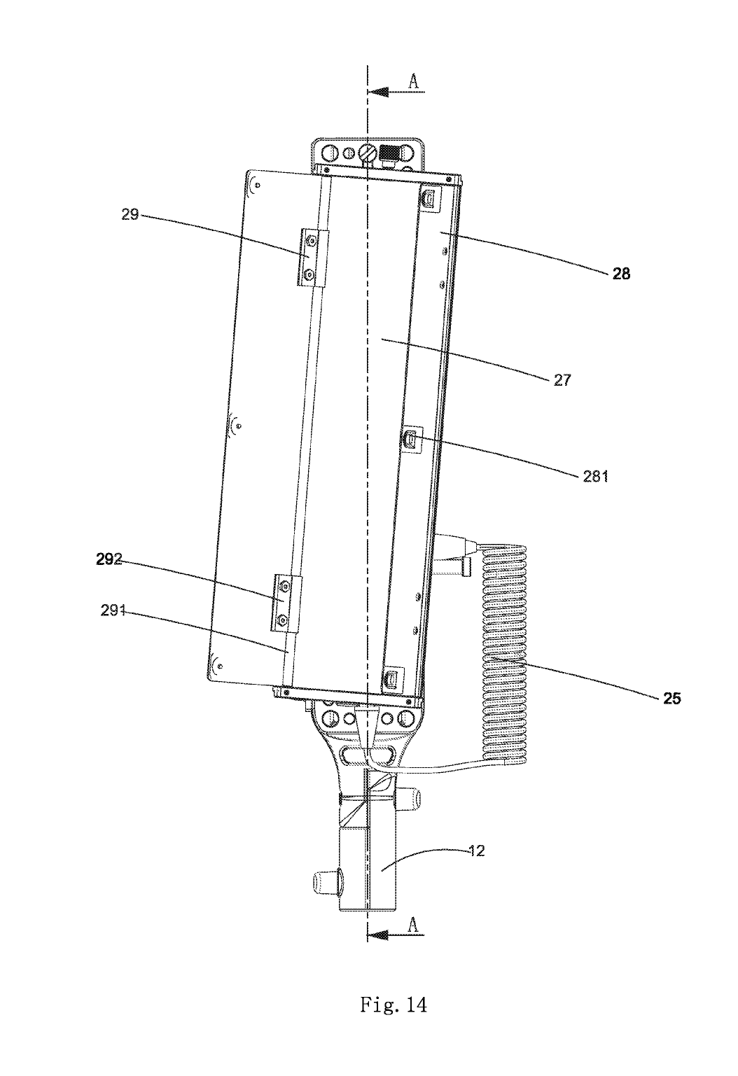

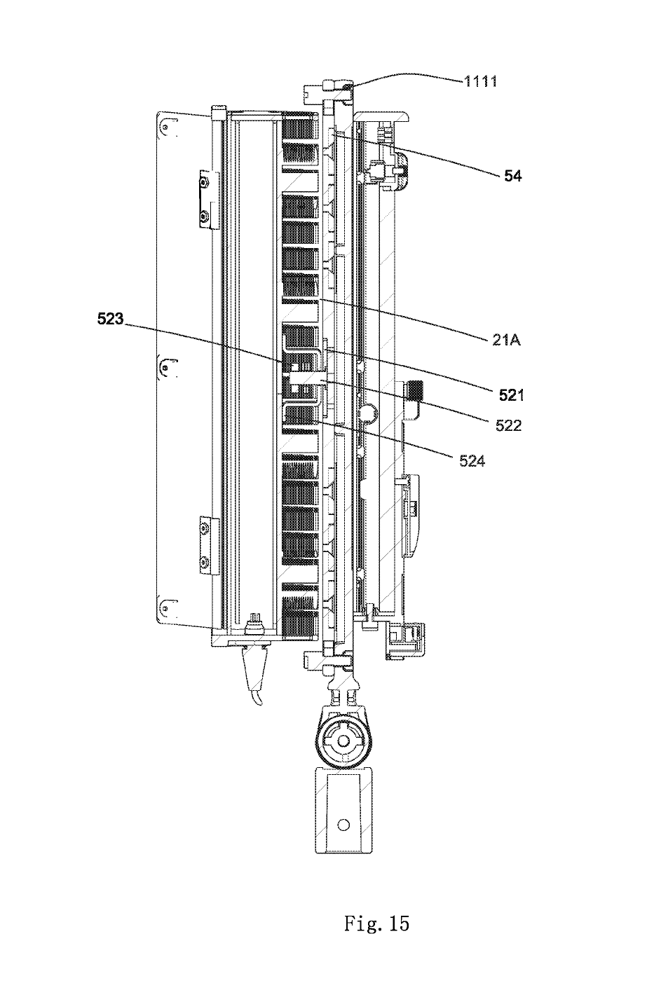

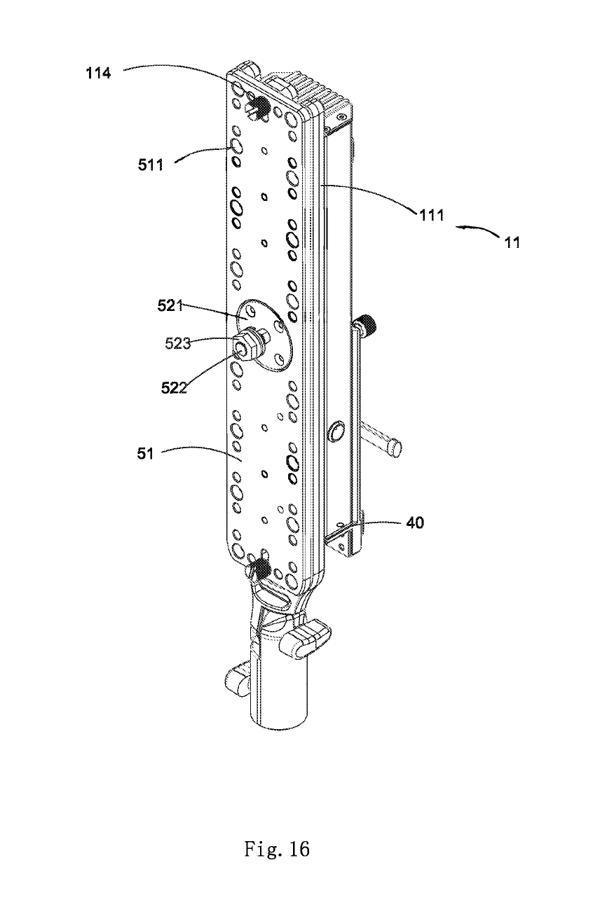

Referring to FIG. 11 to FIG. 16, a set light fixture according to a third preferred embodiment of the present invention is illustrated, and the set light fixture is conveniently applicable to various occasions requiring illumination or special light sources. The set light fixture comprises an adjustment supporting device 10, at least one light source device 20, a light control driver 30, a portable power device 40, and an adapter device 50. The adapter device 50 is arranged between the adjustment supporting device 10 and the light source device 20. The adjustment supporting device 10 can support at least one of the light source devices 20 in a manner that an angle and a height of the light source devices 20 is adjustable. Further, the light source device 20 is detachably mounted at the adapter device 50, wherein the adapter device 50 is fixed to the adjustment supporting device 10. The light control driver 30 is arranged at the adjustment supporting device 10 and electrically connected to the light source device 20 so as to control various functions of the light source device 20. The portable power device 40 is arranged at the light control driver 30, and electrically connected to the light control driver 30 to provide power to the light source device 20. In this way, regardless of whether the photographing or imaging is taken in indoor or outdoor environments, different types of the light source devices 20 can be arranged at the adjustment supporting device 10 through the adapter device 50 according to different needs. And the position and angle of the light source device 20 can be adjusted via the adjustment supporting device 10, and the power can be provided to the light control driver 30 through the portable power device 40 to control the light source device 20 to implement various light patterns. Therefore, the present invention is easily applied to various complicated and varied photographing or imaging environments. In addition, it is worth mentioning that the assembly of the adjustment supporting device 10, the light source device 20, the light control driver 30, the portable power device 40 and the adapter device 50 may be locked by a plurality of connection devices, wherein each of the connection devices can be implemented as a fastening mechanism in which a screw engaging with a screw hole or a nut is employed, but this is not a limitation of the present invention. In other words, it can also be implemented as other engagement such as an engagement between a hook and a slot, and an engagement between a chute and a flange.

According to this preferred embodiment of the invention, the light source device 20 can rotate relative to the adjustment supporting device 10 by the adapter device 50 to adjust a projection area of the light source device 20. The adapter device 50 comprises an adapter plate 51, a rotation device 52, and a plurality of magnetic units 54. The adapter plate 51 has a plurality of common threaded holes 511, such as holes of M6, ¼, ⅜, and elongated holes, for locking the light source device 20 to the adapter plate 51 or quickly dismounting the light source device 20 from the adapter plate 51. Furthermore, the adapter plate 51 has a plurality of the threaded holes 511 which is in different specifications to accommodate various mounting positions and external connectors. Further, the rotation device 52 is arranged in the adapter plate 51 for rotatably connecting the adapter plate 51 and the light source device 20. The plurality of magnetic units 54 are embedded in a side of the adapter plate 51 which is adjacent to the adjustment supporting device 10, such that when the adapter device 50 is disengaged from the adjustment supporting device 10, the light source device 20 can be attracted to any surface of the object that can be magnetically attracted by the magnetic units 54 of the adapter device 50. In addition, while the adapter plate 51 is covered with a protective film in a region which is embedded with the magnetic units 54 in order to protect the magnetic units 54, when the light source device 20 is detached from the adjustment supporting device 10, since the light source device 20 is arranged on the adapter plate 51 of the adapter device 50, the light source device 20 arranged on the adapter device 50 can be further arranged at any surface of the object that can be magnetically attracted by the magnetic units 54 of the adapter device 50. In addition, the rotation device 52 comprises a pressing plate 521, a screw 522, a nut 523, and a rotation member 524, wherein the screw 522 is fixed to the adapter plate 51 via the pressing plate 521. And the rotation member 524 passes through the screw 522 and is retained via the nut 523 and is coupled to the light source device 20. That is to say, the structural relationship between the light source device 20 and the rotation member 524 is fixed, but when the rotation member 524 is rotated relative to the adapter plate 51 with the screw 522 as an axle, the light source device 20 is simultaneously rotated to adjust an illumination mode of the light source.

According to this preferred embodiment of the invention, the adjustment supporting device 10 comprises a handle 11, a holder 12 and an adjustment screw 13. The adapter plate 51 of the adapter device 50 is arranged at the handle 11. The handle 11 is rotatably mounted to the holder 12. Therefore, when the light source device 20 is mounted to the handle 11 via the adapter device 50, it can be rotated relative to the holder 12 to adjust the angle. The adjustment screw 13 is coupled to the handle 11 and the holder 12 for fixing the handle 11 after the handle 11 is adjusted with an angle relative to the holder 12. That is to say, when the light source device 20 is initially arranged at the handle 11 through the adapter device 50, the handle 11 and the holder 12 can be in a released state. And then after the handle 11 and the holder 12 are adjusted to define a predetermined angle, the handle 11 is fixed to the holder 12 at the certain angle by the adjustment screw 13. So, the angle of the light source device 20 relative to the holder 12 is determined at the same time.

According to this preferred embodiment of the present invention, the handle 11 comprises a supporting portion 111, a first adjusting portion 112 and at least two fixing members 114. The light source device 20 is arranged at the supporting portion 111 by the adapter plate 51 of the adapter device 50, and is fixed by the fixing members 114. The first adjusting portion 112 is provided with a first angle adjustment gear 1121. The first adjusting portion 112 is partially extended from the supporting portion 111, and has an arc shape at a distal end. In addition, when the first adjusting portion 112 is partially extended from the supporting portion 111, a notch, which may be a 90-degree notch, is formed corresponding to a non-extending portion. That is to say, when the first adjusting portion 112 is partially extended from the supporting portion 111, a plane and a vertical surface intersecting the plane are simultaneously formed. When the notch is 90 degrees, the plane is a horizontal plane. The first angle adjustment gear 1121 is formed at the first adjusting portion 112. Further, the first angle adjustment gear 1121 is formed at the vertical plane of the first adjusting portion 112, as is shown in FIG. 6.

According to this preferred embodiment of the invention, the holder 12 comprises a body portion 121, a second adjusting portion 122 and a locking member 123. The body portion 121 has a hollow structure. That is to say, the body portion 121 has a hollow groove. In addition, the body portion 121 further has a wall hole 1211 penetrating through a side wall around the hollow groove, such that the holder 12 can be locked with a rod-shaped end with a predetermined thickness in the hollow groove so as to arrange the holder 12 at an article having the rod-shaped end. In other words, when the hollow groove of the body portion 121 of the holder 12 is engaged with the rod-shaped end of the article, the holder 12 is fixed to the article having the rod-shaped end by the locking member 123 passing through the wall hole 1211. So that the height of the handle 11 connected to the holder 12 can be further adjusted, that is to say, the height of the light source device 20 can be adjusted. It is worth mentioning that the article having the rod-shaped end can be implemented as a tripod, so that the set light fixture of the present invention can be arranged anywhere to adjust the height and angle according to the requirements of the shooting occasions to provide illumination and light patterns. Further, the second adjusting portion 122 is partially extended from the body portion 121 of the holder 12, and has an arc shape at the distal end. In addition, when the second adjusting portion 122 is partially extended from the body portion 121, a notch, which may be a 90-degree notch, is formed in the non-extending portion. That is to say, when the second adjusting portion 122 is partially extended from the body portion 121, a plane and a vertical surface intersecting the plane are simultaneously formed. When the notch is 90 degrees, the plane is a horizontal plane. The second adjusting portion 122 is provided with a second angle adjustment gear 1221. Further, the second angle adjustment gear 1221 is formed at the vertical surface of the second adjusting portion 122. It can be understood that when the handle 11 is arranged at the holder 12, the first adjusting portion 112 is located at the notch of the second adjusting portion 122, and the second adjusting portion 122 is located at the notch of the first adjusting portion 112, and the first angle adjustment gear 1121 will be engaged with the second angle adjustment gear 1221 for adjusting the relative angle between the handle 11 and the holder 12, and is locked and fixed by the adjustment screw 13. Therefore, it can be understood that the first adjusting portion 112 of the handle 11 has a first adjusting hole 1122 located at the center of the first angle adjustment gear 1121. The second adjusting portion 122 of the holder 12 has a second adjusting hole 1222 located at the center of the second angle adjustment gear 1221, in which when the first angle adjustment gear 1121 is engaged with the second angle adjusting the gear 1221, the first adjusting hole 1122 is aligned with the second adjusting hole 1222, such that the adjustment screw 13 will penetrate the first adjusting hole 1122 and the second adjusting hole 1222 to lock and fix the relative angle between the handle 11 and the holder 12, as is shown in FIG. 6.

According to this preferred embodiment of the present invention, the supporting portion 111 of the handle 11 has at least two through holes 1111, and a plurality of grooves 1112, in which the two through holes 1111 are respectively located at the head and tail ends of the supporting portion 111. The plurality of grooves 1112 is arranged at an opposite side of the light source device 20. That is to say, the fixing members 114 passing through the two through holes 1111 of the supporting portion 111 to arrange the adapter plate 51 of the adapter device 50 at the supporting portion 111 of the handle 11. At this time, the plurality of grooves 1112 is formed at the supporting portion 111 and is provided at the opposite side of the light source device 20 for dissipating heat and reducing the weight of the handle 11. In other words, the plurality of grooves 1112 form a heat dissipation structure of the light source device 20 and the light control driver 30. Those skilled in the art will appreciate that the grooves 1112 facilitates heat dissipation and reduces mass, but does not constitute a limitation of the handle 11, the handle may be arranged to have a plane structure that does not affect the implementation of the present invention.

According to this preferred embodiment of the present invention, the light source device 20 is implemented as an LED box lamp which comprises a bottom case 21A, a plurality of LED illumination members 22, a light filter 27, and two visors 28. The plurality of LED illumination members 22 is arranged at the bottom case 21A, and the light filter 27 covers the upper portion thereof. The visors 28 are arranged at both sides of the LED lamp 22 and the light filter 27 for adjusting the angle and range of the light. The bottom case 21A, which is formed with a receiving groove having an opening, are arranged with a plurality of heat dissipation fins at a side thereof, and two sliding grooves are provided near the opening of the receiving groove for receiving the light filter 27. And when the two sides of the light filter 27 are respectively arranged at the sliding groove, a locker member is provided for fixing the light filter 27 to the bottom case 21A. In addition, the light source device 20 further comprises two sets of movable members 29 for respectively mounting the two visors 28 to the bottom case 21A. Each set of the movable members 29 comprises a rotation shaft 291 and a plurality of rotation fixing members 292, wherein the visors 28 are respectively fixed to the rotation fixing members 292, and the rotation fixing members 292 are respectively movably mounted on the rotation shafts 291, such that the visors 28 will be rotated relative to the bottom case 21A at the rotation shaft 29 with the help of the rotation fixing member 292 to adjust the angle and range of the light. In addition, each of the visors 28 further comprises a plurality of clamps 281 arranged at an edge of the visor 28 for holding a light filter fabric. The light source device 20 further comprises a power signal line 25 for connecting the light source device 20 with the light control driver 30.

In accordance with this preferred embodiment of the present invention, the light control driver 30 comprises a driver body, at least an adjusting component and a protective cover. The adjusting component is arranged at the driver body, which is arranged at an edge of the driver body and is protruded therefrom for convenient operation. But it is easily damaged by collision during carrying, thus the protective cover is provided with a protrusion which is mated with the adjusting component to protect it. Additionally, the adjusting element can be implemented as at least one knob or at least one switch, such that the protective cover with the protrusion is mated with the knob or the switch to protect the knob or the switch.

According to this preferred embodiment of the invention, the portable power device 40 comprises a battery holder and at least a battery unit. The battery holder is arranged at the light control driver 30. The battery unit is detachably mounted to the battery holder. It is worth mentioning that when applied to different cameras, the battery holders can also be of different types to fit battery power sources of different types of cameras, such as a battery power source of a U-type camera, a battery power source of a V-type camera, and a battery power source for a V-type camera without a power interface. That is to say, the present invention provides three types of battery holders for replacement in accordance with existing battery models to increase the utility of the kit of the present invention, as shown in FIG. 24 to FIG. 26.

The invention also provides an application method of the set light fixture, comprising steps of:

(A) arranging the light source device 20 at the adapter device 50;

(B) detachably mounting the adapter device 50 to the adjustment supporting device 10;

(C) changing the angle of the light source device 20 by adjusting the handle 11, the holder 12 and the adjustment screw 13; and

(D) electrically connecting the portable power device 40 to the light source control driver 30 to operate the light source device 20.

According to the step (A), wherein the adapter device 50 comprises a plurality of the magnetic units 54, such that the light source device 20 can be attached to any surface of the object that can be magnetically attracted by the magnetic units 54 of the adapter device 50.

According to step (A), the light source device 20 is embodied as an LED box lamp.

According to the step (A), the light source device 20 comprises two visors 28 each of which comprises a plurality of clamps 281 arranged at an edge thereof for holding the light filter fabric.

According to the step (A), the light source device 20 comprises two sets of the movable members 29 which movably mount the two visors 28 on both sides of the light source device 20 respectively.

According to the step (A), the light source device 20 further comprises the power signal line 25 for connecting the light source device 20 with the light control driver 30.

According to the step (B), the adapter device comprises the adapter plate 51 having a plurality of common threaded holes 511, such as holes of M6, ¼, ⅜, and elongated holes, etc., for quickly locking or dismounting the light source device 20 from the adapter plate 51.

According to the step (B), the adapter device 50 comprises the rotation device 52 such that the light source device 20 can be rotatable relative to the adjustment supporting device 10.

According to the step (C), the first adjusting portion 112 of the handle 11 is provided with the first angle adjustment gear 1121, and the second adjusting portion 122 of the holder 12 is provided with the second angle adjustment gear 1221, wherein the first angle adjustment gear 1121 is engaged with the second angle adjustment gear 1221 which is locked or released by the adjustment screw 13.

According to the step (C), when the first angle adjustment gear 1121 and the second angle adjustment gear 1221 are not tightly engaged, the handle 11 can be relatively rotatable relative to the holder 12 to change the angle of the light source device 20 relative to the support device 10, and is locked by the adjustment screw 13 after adjustment.

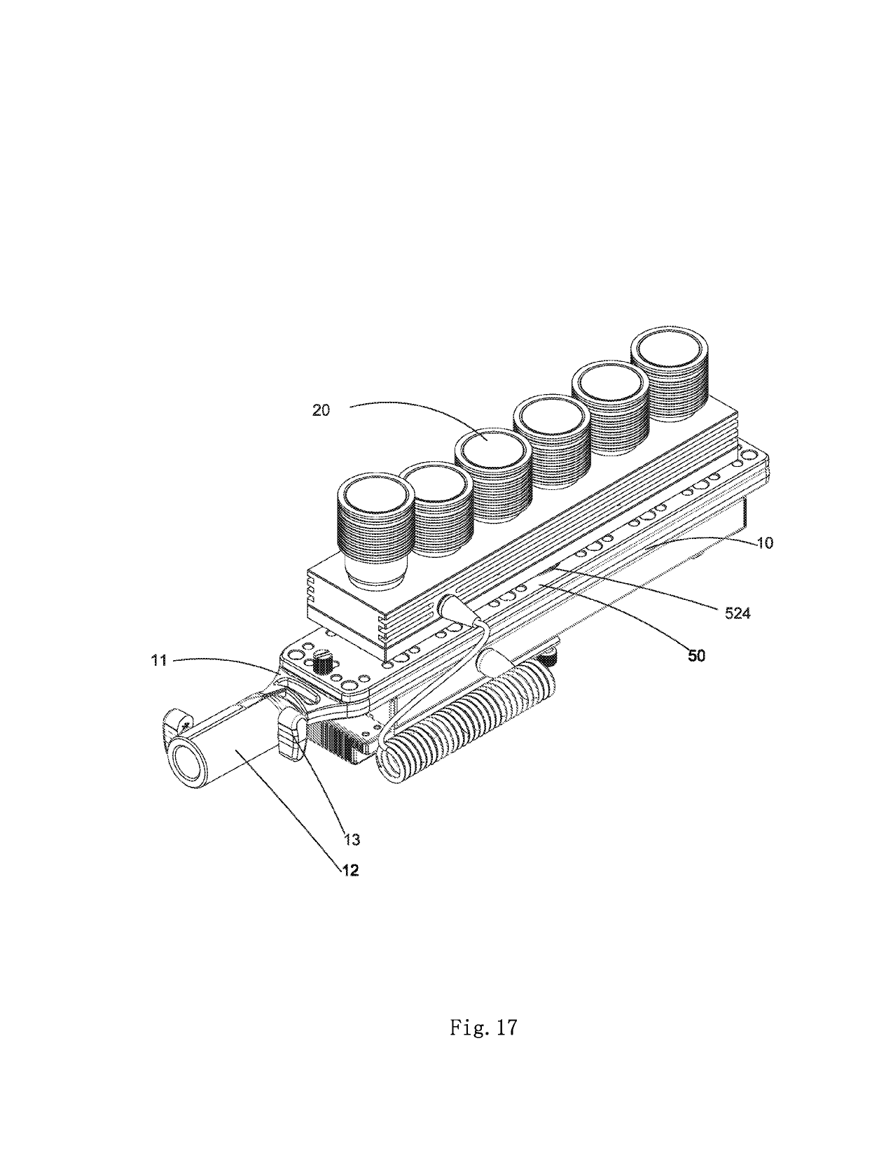

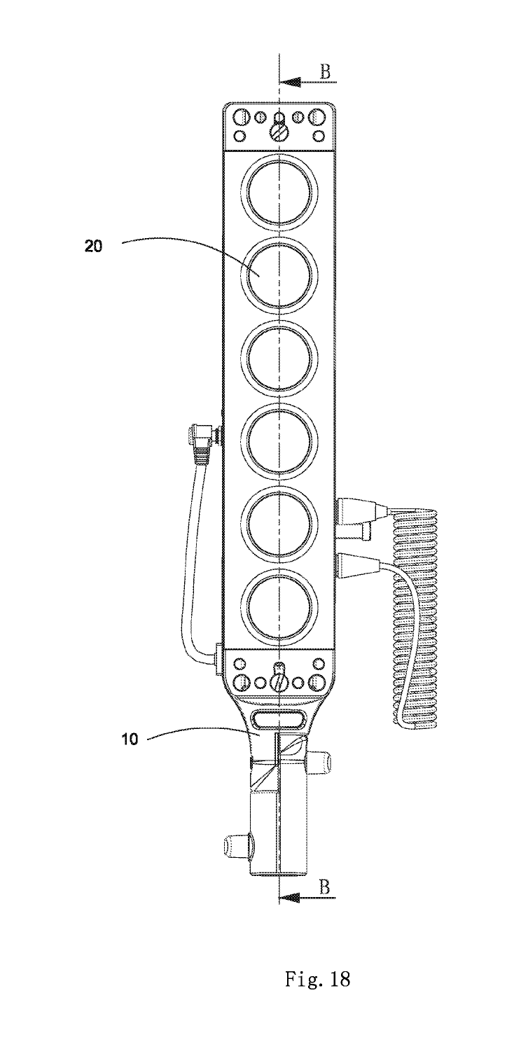

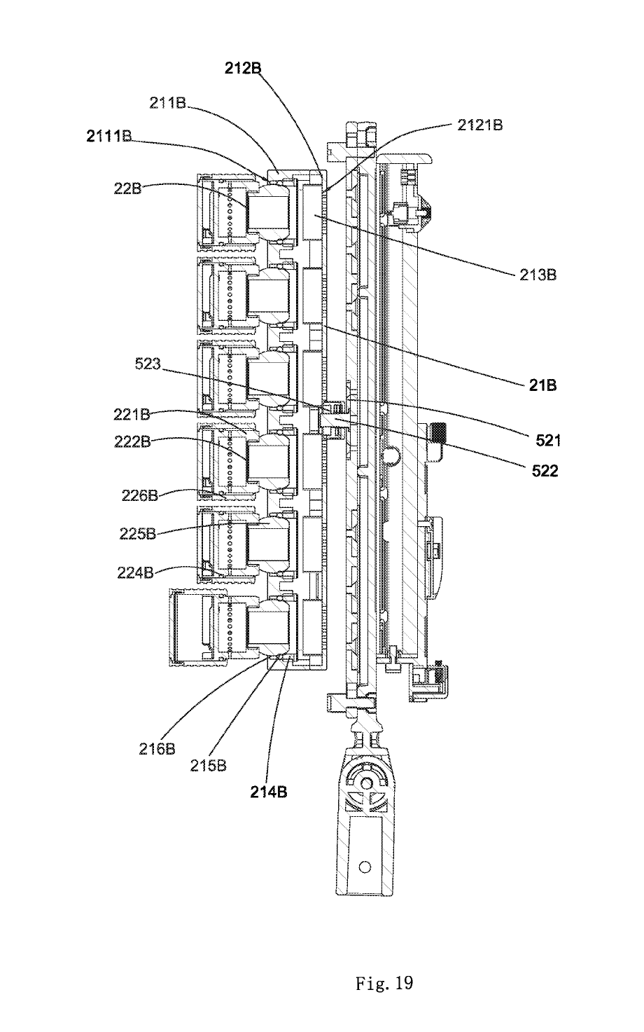

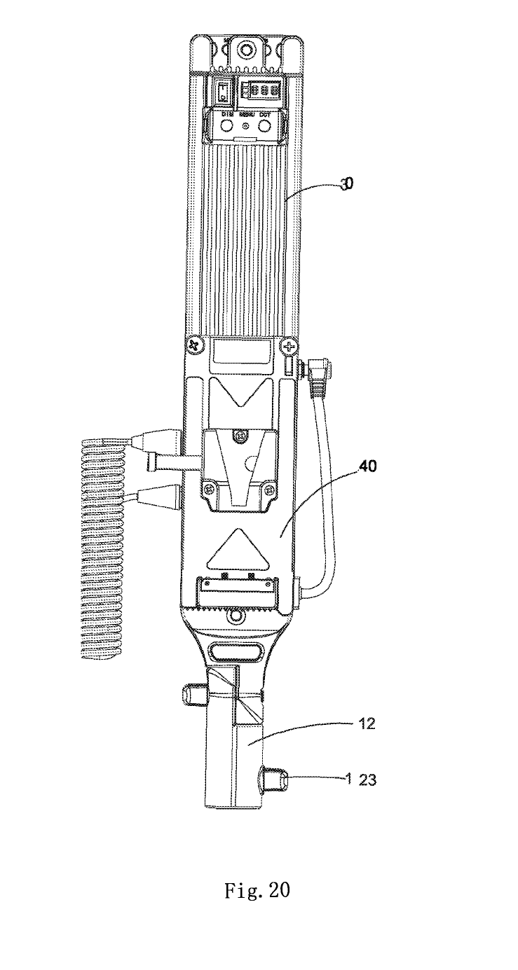

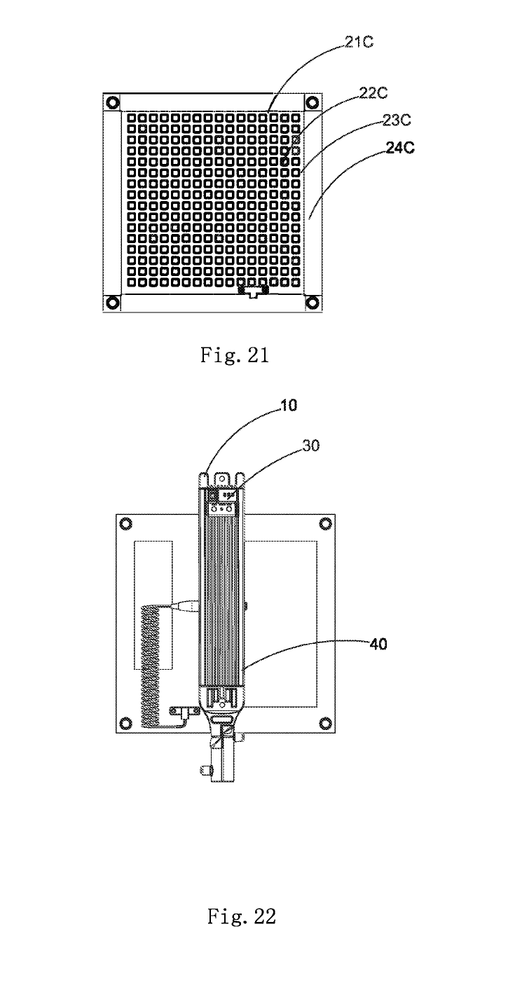

Referring to the FIG. 17 to FIG. 20, a set light fixture according to a fourth preferred embodiment of the present invention is illustrated, and the set light fixture can be conveniently applicable to various occasions requiring illumination or special light sources, and to provide light sources of different focal lengths for use in each kind of photographing environments.

The set light fixture comprises an adjustment supporting device 10, at least one light source device 20, a light control driver 30, a portable power device 40, and an adapter device 50. The adapter device 50 is arranged between the adjustment supporting device 10 and the light source device 20. The adjustment supporting device 10 can support at least one of the light source devices 20 in such a manner that an angle and a height of the light source device 20 are adjustable. Further, the light source device 20 is detachably mounted at the adapter device 50, wherein the adapter device 50 is fixed to the adjustment supporting device 10. The light control driver 30 is arranged at the adjustment supporting device 10 and electrically connected to the light source device 20 so as to control various functions of the light source device 20. The portable power device 40 is arranged at the light control driver 30, and electrically connected to the light control driver 30 to provide power to the light source device 20. In this way, regardless of indoor or outdoor photographing or imaging, different types of the light source devices 20 can be arranged at the adjustment supporting device 10 through the adapter device 50 according to different needs. And the position and angle of the light source device 20 can be adjusted via the adjustment supporting device 10, and the power can be provided to the light control driver 30 through the portable power device 40 to control the light source device 20 to implement various light patterns. Therefore, the present invention is easily applied to various complicated and varied photographing or imaging environments. In addition, it is worth mentioning that the assembly of the adjustment supporting device 10, the light source device 20, the light control driver 30, the portable power device 40 and the adapter device 50 may be locked by a plurality of connection devices, wherein the connection device can be implemented as a fastening mechanism in which a screw engaging with a screw hole or a nut is employed, but this is not a limitation of the present invention. In other words, it can also be implemented as other engagement such as an engagement between a a hook and a slot, and an engagement between a chute and a flanget.

According to this preferred embodiment of the invention, the adapter device 50 comprises an adapter plate 51, a rotation device 52, and a plurality of magnetic units 54. The adapter plate 51 has a plurality of common threaded holes 511, such as holes of M6, ¼, ⅜, and elongated holes, for locking the light source device 20 to the adapter plate 51 or dismounting the light source device 20 from the adapter plate 51 quickly. Furthermore, the adapter plate 51 has a plurality of the threaded holes 511 in different specifications to accommodate various mounting positions and external connectors. Further, the rotation device 52 is arranged in the adapter plate 51 for rotatably connecting the adapter plate 51 with the light source device 20. The plurality of magnetic units 54 is embedded in a side of the adapter plate 51 adjacent to the adjustment supporting device 10, such that when the adapter device 50 is disengaged from the adjustment supporting device 10, the light source device 20 can be attracted to any surface of the object that can be magnetically attracted by the magnetic units 54 of the adapter device 50. In addition, while the adapter plate 51 is covered with a protective film in a region which is embedded with the magnetic units 54 in order to protect the magnetic unit 54, when the light source device 20 is detached from the adjustment supporting device 10, since the light source device 20 is still arranged at the adapter plate 51 of the adapter device 50, the light source device 20 arranged on the adapter plate 51 can be further arranged at any surface of the object that can be magnetically attracted by the magnetic units 54 of the adapter device 50. In addition, the rotation device 52 comprises a pressing plate 521, a screw 522, a nut 523, and a rotation member 524, wherein the screw 522 is fixed to the adapter plate 51 via the pressing plate 521. And the rotation member 524 passes through the screw 522 and is constrained via the nut 523 and is coupled to the light source device 20. That is to say, the structural relationship between the light source device 20 and the rotation member 524 is fixed, but when the rotation member 524 is rotated relative to the adapter plate 51 with the screw 522 as an axle, the light source device 20 is simultaneously rotated to adjust an illumination mode of the light source.

According to this preferred embodiment of the invention, the adjustment supporting device 10 comprises a handle 11, a holder 12 and an adjustment screw 13. The adapter plate 51 of the adapter device 50 is arranged at the handle 11. The handle 11 is rotatably mounted to the holder 12. Therefore, when the light source device 20 is mounted to the handle 11 via the adapter device 50, it can be rotated relative to the holder 12 to adjust the angle. The adjustment screw 13 is coupled to the handle 11 and the holder 12 for fixing the handle 11 after the handle 11 is adjusted with an angle relative to the holder 12. That is to say, when the light source device 20 is initially arranged at the handle 11 through the adapter device 50, the handle 11 and the holder 12 are in a released state. And then after the handle 11 and the holder 12 are adjusted to define a predetermined angle, the handle 11 is fixed to the holder 12 at the predetermined angle by the adjustment screw 13. So, the angle of the light source device 20 relative to the holder 12 is determined at the same time.

According to this preferred embodiment of the present invention, the handle 11 comprises a supporting portion 111, a first adjusting portion 112 and at least two fixing members 114. The light source device 20 is arranged at the supporting portion 111 by the adapter plate 51 of the adapter device 50, and is fixed by the fixing members 114. The first adjusting portion 112 is provided with a first angle adjustment gear 1121. The first adjusting portion 112 is partially extended from the supporting portion 111, and has an arc shape at a distal end. In addition, when the first adjusting portion 112 is partially extended from the supporting portion 111, a notch, which may be a 90-degree notch, is formed at a non-extending portion. That is to say, when the first adjusting portion 112 is partially extended from the supporting portion 111, a plane and a vertical surface intersecting the plane are simultaneously formed. When the notch is 90 degrees, the plane is a horizontal plane. The first angle adjustment gear 1121 is formed at the first adjusting portion 112. Further, the first angle adjustment gear 1121 is formed at the vertical plane of the first adjusting portion 112, as is shown in FIG. 6.

According to the preferred embodiment of the invention, the holder 12 comprises a body portion 121, a second adjusting portion 122 and a locking member 123. The body portion 121 is a hollow structure. That is to say, the body portion 121 has a hollow groove. In addition, the body portion 121 further has a wall hole 1211 penetrating through a side wall around the hollow groove, such that the holder 12 can be locked with a rod-shaped end with a certain thickness in the hollow groove so as to arrange the holder 12 at an article having the rod-shaped end. In other words, when the hollow groove of the body portion 121 of the holder 12 is engaged with the rod-shaped end of the article, the holder 12 is fixed to the article having the rod-shaped end by the locking member 123 passing through the wall hole 1211. So that the height of the handle 11 connected to the holder 12 can be further adjusted, that is to say, the height of the light source device 20 can be adjusted. It is worth mentioning that the article having the rod-shaped end can be implemented as a tripod, so that the set light fixture of the present invention can be arranged anywhere to adjust the height and angle according to the requirements of the shooting occasions to provide illumination and light patterns. Further, the second adjusting portion 122 is partially extended from the body portion 121 of the holder 12, and has an arc shape at the distal end. In addition, when the second adjusting portion 122 is partially extended from the body portion 121, a notch, which may be a 90-degree notch, is formed in a non-extending portion. That is to say, when the second adjusting portion 122 is partially extended from the body portion 121, a plane and a vertical surface intersecting the plane are simultaneously formed. When the notch is 90 degrees, the plane is a horizontal plane. The second adjusting portion 122 is provided with a second angle adjustment gear 1221. Further, the second angle adjustment gear 1221 is formed at the vertical surface of the second adjusting portion 122. It can be understood that when the handle 11 is arranged at the holder 12, the first adjusting portion 112 is located at the notch of the second adjusting portion 122, and the second adjusting portion 122 is located at the notch of the first adjusting portion 112, and the first angle adjustment gear 1121 will be engaged with the second angle adjustment gear 1221 for adjusting the relative angle of the handle 11 and the holder 12, which is locked and fixed by the adjustment screw 13. Therefore, it can be understood that the first adjusting portion 112 of the handle 11 has a first adjusting hole 1122 located at a center of the first angle adjustment gear 1121. The second adjusting portion 122 of the holder 12 has a second adjusting hole 1222 located at a center of the second angle adjustment gear 1221, in which when the first angle adjustment gear 1121 is engaged with the second angle adjusting the gear 1221, the first adjusting hole 1122 is aligned with the second adjusting hole 1222, such that the adjustment screw 13 will penetrate the first adjusting hole 1122 and the second adjusting hole 1222 to lock and fix the relative angle of the handle 11 and the holder 12, as is shown in FIG. 6.

According to the preferred embodiment of the present invention, the supporting portion 111 of the handle 11 has at least two through holes 1111, and a plurality of grooves 1112, in which the two through holes 1111 are respectively located at the head and tail ends of the supporting portion 111. The plurality of grooves 1112 is arranged at an opposite side of the light source device 20. That is to say, the fixing members 114 passing through the two through holes 1111 of the supporting portion 111 is able to arrange the adapter plate 51 of the adapter device 50 at the supporting portion 111 of the handle 11. At this time, the plurality of grooves 1112 is formed at the supporting portion 111 and is provided at the opposite side of the light source device 20 for dissipating heat and reducing the weight of the handle 11. In other words, the plurality of grooves 1112 form a heat dissipation structure of the light source device 20 and the light control driver 30. Those skilled in the art will appreciate that the grooves 1112 facilitates heat dissipation and reduces mass, but does not constitute a limitation of the handle 11, the handle 11 also may be arranged to have a plane structure that does not affect the implementation of the present invention.

In accordance with this preferred embodiment of the present invention, the light source device 20 is implemented as an LED zoom lamp which comprises a heat sink casing 21B and a plurality of LED zoom spotlights 22B. The plurality of the LED zoom spotlights 22B are arranged at the heat sink casing 21B. The heat sink casing 21B comprises an upper housing 211B, a lower housing 212B, a plurality of fans 213B, a plurality of locking covers 214B, a plurality of rubber rings 215B, and a plurality of gaskets 216B. The upper housing 211B has a plurality of placing holes 2111B for arranging the LED zoom spotlights 22B. The lower housing 212B has a plurality of sets of heat dissipation holes 2121B, wherein when the upper housing 211B is connected to the lower housing 212B, each set of the heat dissipation holes 2121B is aligned with the placing hole 2111B for discharging the thermal energy generated by the LED zoom spotlights 22B. The plurality of fans 213B are respectively corresponding to each set of the heat dissipation holes 2121B and are locked to the lower housing 212B. Each of the locking covers 214B is respectively locked to the placing hole 2111B of the upper housing 211B, and the gaskets 216B and the rubber rings 215B are respectively press-fitted to the placing holes 2111B of the upper housing 211B to achieve the function of waterproof and shockproof. Therefore, the plurality of LED zoom spotlights 22B is respectively locked to the heat sink casing 21B via a plurality of the locking covers 214B, wherein a plurality of the fans 213B is respectively corresponding to the LED zoom spotlights 22B to discharge the heat energy generated by the LED zoom spotlights 22B into the heat sink casing 21B through the heat dissipation holes 2121B. In addition, each of the LED zoom spotlights 22B comprises a supporting base 221B, at least an LED illumination member 222B, a light cover 223B, an adjusting ring 224B, a ball head element 225B, and a telescopic adjusting element 226B, wherein the LED illumination member 222B is arranged at the supporting base 221B, wherein the lamp cover 223B is arranged above the LED illumination member 222B. The ball head element 225B is arranged at the bottom of the supporting base 221B, so that when connecting to the heat sink casing 21B, the LED zoom spotlights 22B can be rotatably adjusted at any angle within a certain range. The telescopic adjusting member 226B, with the adjusting ring 224B, is arranged at the supporting base 221B. In particular, the telescopic adjusting element 226B can be moved up and down relative to the supporting base 221B to change the focal length of the LED illumination member 222B. Also, the light cover 223B can be implemented as a zoom lens, and is further implemented as a Fresnel zoom lens, of which the condensed light has a characteristic that an edge of a spot is blurred, that is to sat, a boundary is blurred, which is suitable for the photographic camera light. The light source device 20 further comprises a power signal line 25 for connecting the light source device 20 with the light control driver 30.

In accordance with this preferred embodiment of the present invention, the light control driver 30 comprises a driver body, at least an adjusting component and a protective cover. The adjusting component is arranged at the driver body, which is arranged at an edge of the driver body and is protruded therefrom for convenient operation. But it is easily damaged by collision during carrying, thus the protective cover is provided with a protrusion which is mated with the adjusting component to protect it. Additionally, the adjusting element can be implemented as at least one knob or at least one switch, such that the protective cover with the protrusion is mated with the knob or the switch to protect the knob or the switch.

According to this preferred embodiment of the invention, the portable power device 40 comprises a battery holder and at least a battery unit. The battery holder is arranged at the light control driver 30. The battery unit is detachably mounted to the battery holder. It is worth mentioning that when applied to different cameras, the battery holders can also be of different types to fit battery power sources of different types of cameras, such as a battery power source of a U-type camera, a battery power source of a V-type camera, and a battery power source for a V-type camera without a power interface. That is to say, the present invention provides three types of battery holders for replacement in accordance with existing battery models to increase the utility of the kit of the present invention, as shown in FIG. 24 to FIG. 26.

The invention also provides an application method of the set light fixture, comprising steps of:

(A) arranging the light source device 20 at the adapter device 50;

(B) detachably mounting the adapter device 50 to the adjustment supporting device 10;

(C) changing the angle of the light source device 20 by adjusting the handle 11, the holder 12 and the adjustment screw 13; and

(D) electrically connecting the portable power device 40 to the light control driver 30 to operate the light source device 20.

According to the step (A), wherein the adapter device 50 comprises a plurality of magnetic units 54, such that the light source device 20 can be attracted to any surface of the object that can be magnetically attracted by the magnetic units 54 of the adapter device 50.

According to step (A), the light source device 20 is embodied as an LED zoom lamp.

According to the step (A), the light source device 20 comprises a heat sink casing 21B and a plurality of LED zoom spotlights 22B disposed in the heat sink casing 21B.

According to the step (A), the heat sink casing 21B comprises a plurality of fans 213B facing towards the plurality of the LED zoom spot lamps 22B for dissipating heat energy.

According to the step (A), the LED zoom spotlight 22B comprises a ball head element 225B disposed at the heat sink casing 21B to rotatably adjust the LED zoom spotlight 22B at an arbitrary angle within a predetermined range.

According to the step (A), the LED zoom spotlight 22B comprises a supporting base 221B and a telescopic adjusting element 226B, wherein the telescopic adjusting element 226B moves up and down relative to the supporting base 221B to change a focal length of the LED illumination member 222B.

According to step (A), wherein the LED zoom spotlight 22B comprises a light cover 223B which is implemented as a Fresnel zoom lens.

According to the step (A), the light source device 20 further comprises the power signal line 25 for connecting the light source device 20 with the light control driver 30.

According to the step (B), the adapter device comprises the adapter plate 51 having a plurality of common threaded holes 511, such as holes of M6, ¼, ⅜, and elongated holes, etc., for quickly locking or dismounting the light source device 20 from the adapter plate 51.

According to the step (B), the adapter device 50 comprises the rotation device 52 such that the light source device 20 can be rotatable relative to the adjustment supporting device 10.

According to the step (C), the first adjusting portion 112 of the handle 11 is provided with the first angle adjustment gear 1121, and the second adjusting portion 122 of the holder 12 is provided with the second angle adjustment gear 1221, wherein the first angle adjustment gear 1121 is engaged with the second angle adjustment gear 1221 which is locked or released by the adjustment screw 13.

According to the step (C), when the first angle adjustment gear 1121 and the second angle adjustment gear 1221 are not tightly engaged, the handle 11 can be relatively rotatable relative to the holder 12 to change the angle of the light source device 20 relative to the support device 10, and is locked by the adjustment screw 13 after adjustment.

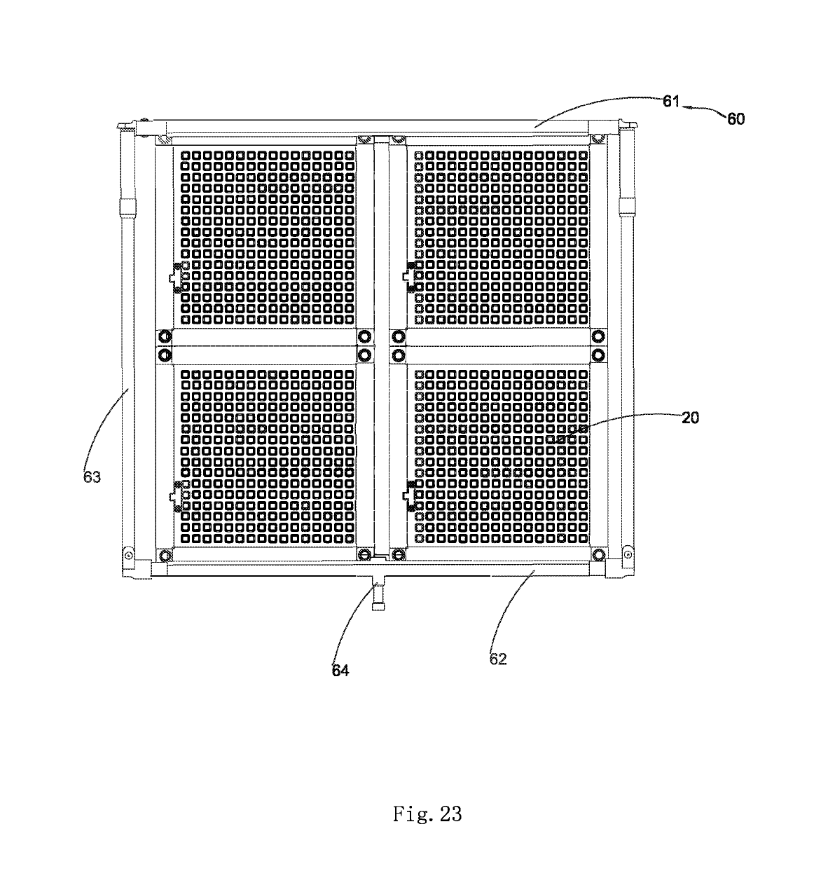

Referring to FIG. 22 to FIG. 23, a set light fixture according to a fifth preferred embodiment of the present invention is shown, the set light fixture can be conveniently applicable to various occasions requiring illumination or special light sources, and are particularly suitable for various photographing or imaging environments or needs, or the situation requiring a relatively large area illumination.

In accordance with this preferred embodiment of the present invention, the set light fixture comprises at least a light source device 20, a light control driver 30, and a portable power device 40. The light control driver 30 is electrically connected to the light source device 20 and the portable power device 40 to provide power through the portable power device 40 to operate the light source device 20.

Additionally, the set light fixture of the present invention further comprises an adjustment supporting device 10, wherein the adjustment supporting device 10 can support at least one of the light source devices 20 with varying angles and heights. Further, the light source device 20 is detachably mounted to the adjustment supporting device 10. The light control driver 30 is arranged at the adjustment supporting device 10 and electrically connected to the light source device 20, thereby controlling various functions of the light source device 20. The portable power device 40 is arranged at the adjustment supporting device 10 and electrically connected to the light control driver 30 to provide power to the light source device 20. In this way, different types of the light source device 20 can be arranged at the adjustment supporting device 10 according to different needs in indoor or outdoor photographing or imaging occasions. And the position and angle of the light source device 20 can be adjusted by the adjustment supporting device 10, as well as the power can be provided to the light control driver 30 via the portable power device 40, thereby controlling the light source device 20 to achieve various light patterns. Therefore, the present invention is easily applied to various complicated and varied photographing or imaging environments. In addition, the light control driver 30 and the portable power device 40 are arranged at the adjustment supporting device 10 side-by-side to reduce the thickness of the set light fixture. In addition, it is worth mentioning that when the light control driver 30 and the portable power device 40 are arranged at the adjustment supporting device 10, they can be locked by a plurality of connection devices, wherein the connection device can be implemented as the fastening mechanism of a screw engaging with a screw hole or a nut matched, but this is not a limitation of the invention, that is to say, it can also be implemented as other engagement such as an engagement between a hook and a slot.

According to this preferred embodiment of the invention, the light source device 20 is embodied as an LED flag board light. The source device 20 comprises a bottom plate 21C, a plurality of LED illumination members 22C, a protective film 23C, and a plurality of attaching members 24C. The bottom plate 21C is made of a flexible material. It is worth mentioning that the LED flag board light adopts a waterproof fabric. The plurality of LED illumination members 22C is arranged in an array arrangement at the bottom plate 21C. The protective film 23C is covered over the plurality of the LED illumination members 22C by a vacuum molding process to provide a waterproof and moisture-proof protection function. And the uniformity of protective film 23 at the bottom plate 21 is not affected while the bottom plate 21 is bended because of the vacuum molding process, thereby keeping the uniformity of the light emitted by the LED illumination members 22 from being affected by the bending of the bottom plate 21. The plurality of the attaching members 24C are arranged at the edges of the front and back surfaces of the bottom plate 21C, so that the joining can be simply realized to provide the combined light source devices 20 with a larger illumination range. Further, the attaching elements 24C are implemented as Velcro members. Therefore, the mating velcro member are respectively provided at the edges of the front and back surfaces of the bottom plate 21C to join the plurality of the light source devices 20. In addition, the corners of the bottom plate 21C are provided with holes to fix the light source device 20 by a simple suspension way.

The set light fixture of the present invention further comprises a supporting set 60 for supporting the light source device 20, wherein the supporting set comprises an upper rod 61, a lower rod 62, two side rods 63, and a connecting rod 64. In this way, the light source device 20 or the LED flag board lights combination is fixed to the upper rod 61 and the lower rod 62, and the two side rods 63 are arranged at two ends of the upper rod 61 and the lower rod 62, wherein the two side rods 63 are flexible telescopic rods that can adjusts their height according to the joining configuration of the light source devices 20. In addition, the lower ends of the two side rods 63 and the two ends of the lower rod 62 are pivotally connected. Each of the two ends of the upper rod 61 has a pin hole, and each of the upper ends of the two side rods 63 has a latch, so that the pin of the side rod 63 is used for cooperating with the pin hole of the upper rod 61 to facilitate the support or storage of the light source device 20. In addition, the connecting rod 64 is arranged in the middle of the lower rod to adapt to be inserted in various slots or holes, such as a groove or hole of some brackets, for conveniently using the light source device 20. That is to say, the preferred embodiment can be directly used in conjunction with the light control driver 30 and the mobile power unit 40 depending on the needs of use without the use of the adjustment supporting device 10. However, the light source device 20 of the preferred embodiment can also be arranged at the adjustment supporting device 10 according to different needs, and used in conjunction with the light control driver and the portable power device 40, which is not a limitation of the present invention.

According to this preferred embodiment of the present invention, the light source device 20 further comprises a power signal line 25 and a wire fixer 26. The wire fixer 26 fixes the power signal line 25 to the bottom plate 21C of the light source device 20.

According to this preferred embodiment of the invention, the adjustment supporting device 10 comprises a handle 11, a holder 12 and an adjustment screw 13. The light source device 20 is arranged at the handle 11. The handle 11 is rotatably mounted at the holder 12. Therefore, the light source device 20 can be rotated relative to the holder 12 to adjust the angle. The adjustment screw 13 is connected to the handle 11 and the holder 12 for fixing the handle 11 after the handle 11 is adjusted with an angle relative to the holder 12. In other words, when the light source device 20 is initially arranged at the handle 11, the handle 11 and the holder 12 can be in a released state. And then after the handle 11 and the holder 12 are adjusted to define a certain angle, the handle 11 is fixed to the holder 12 at the certain angle by the adjustment screw 13. So, the angle of the light source device 20 relative to the holder 12 is determined at the same time.

According to this preferred embodiment of the invention, the handle 11 comprises a supporting portion 111 and a first adjusting portion 112. The light source device 20 is arranged at the supporting portion 111. The first adjusting portion 112 is provided with a first angle adjustment gear 1121. The first adjusting portion 112 is partially extended from the supporting portion 111 and has an arc shape at the end. In addition, when the first adjusting portion 112 is partially extended from the supporting portion 111, a notch, which may be a 90-degree notch, is formed at the non-extending portion. That is to say, when the first adjusting portion 112 is partially extended from the supporting portion 111, a plane and a vertical surface intersecting the plane are simultaneously formed. When the gap is 90 degrees, the plane is a horizontal plane. The first angle adjustment gear 1121 is formed at the first adjusting portion 112. Further, the first angle adjustment gear 1121 is formed at the vertical plane of the first adjusting portion 112. In addition, the handle 11 may further comprise at least two clamping elements 113 and at least two fixing elements 114. When the light source device 20 is arranged at the supporting portion 111, the upper rod 61 and the lower rod 62 located at the light source device 20 are supported by the two clamping elements 113 respectively. And then the fixing member 114 fixes the upper rod 61 and the lower rod 62 to the supporting portion 111.

According to this preferred embodiment of the invention, the holder 12 comprises a body portion 121, a second adjusting portion 122 and a locking member 123. The body portion 121 has a hollow structure. That is to say, the body portion 121 has a hollow groove. In addition, the body portion 121 further has a wall hole 1211 penetrating through a side wall around the hollow groove, such that the holder 12 can be locked with a rod-shaped end with a certain thickness in the hollow groove so as to arrange the holder 12 at an article having the rod-shaped end. In other words, when the hollow groove of the body portion 121 of the holder 12 is engaged with the rod-shaped end of the article, the holder 12 is fixed to the article having the rod-shaped end by the locking member 123 passing through the wall hole 1211. So that the height of the handle 11 connected to the holder 12 can be further adjusted, that is to say, the height of the light source device 20 can be adjusted. It is worth mentioning that the article having the rod-shaped end can be implemented as a tripod, so that the set light fixture of the present invention can be arranged anywhere to adjust the height and angle according to the requirements of the shooting occasions to provide illumination and light patterns. Further, the second adjusting portion 122 is partially extended from the body portion 121 of the holder 12, and has an arc shape at a distal end. In addition, when the second adjusting portion 122 is partially extended from the body portion 121, a notch, which may be a 90-degree notch, is formed in the non-extending portion. That is to say, when the second adjusting portion 122 is partially extended from the body portion 121, a plane and a vertical surface intersecting the plane are simultaneously formed. When the notch is 90 degrees, the plane is a horizontal plane. The second adjusting portion 122 is provided with a second angle adjustment gear 1221. Further, the second angle adjustment gear 1221 is formed at the vertical surface of the second adjusting portion 122. It can be understood that when the handle 11 is arranged at the holder 12, the first adjusting portion 112 is located at the notch of the second adjusting portion 122, and the second adjusting portion 122 is located at the notch of the first adjusting portion 112, and the first angle adjustment gear 1121 will be engaged with the second angle adjustment gear 1221 for adjusting the relative angle between the handle 11 and the holder 12, and is locked and fixed by the adjustment screw 13. Therefore, it can be understood that the first adjusting portion 112 of the handle 11 has a first adjusting hole 1122 located at a center of the first angle adjustment gear 1121. The second adjusting portion 122 of the holder 12 has a second adjusting hole 1222 located at a center of the second angle adjustment gear 1221, in which when the first angle adjustment gear 1121 is engaged with the second angle adjusting the gear 1221, the first adjusting hole 1122 is aligned with the second adjusting hole 1222, such that the adjustment screw 13 will penetrate the first adjusting hole 1122 and the second adjusting hole 1222 to lock and fix the relative angle of the handle 11 and the holder 12, as is shown in FIG. 6.

According to this preferred embodiment of the present invention, the supporting portion 111 of the handle 11 has at least two through holes 1111, and a plurality of grooves 1112, wherein the two through holes 1111 are respectively located at the head and tail ends of the supporting portion 111. The plurality of grooves 1112 is located at the opposite side of the light source device 20. That is to say, when the light source device 20 is arranged at the supporting portion 111 of the handle 11, the clamping elements 113 support the upper rod 61 and the lower rod 62 arranged at the light source device 20 at the head and the tail ends of the light source device 20, and the fixing members 114 pass through the clamping elements 113 and the two through holes 1111 of the supporting portion 111 respectively to fix the light source device 20 to the supporting portion 111 of the handle 11. At this time, the plurality of grooves 1112 is formed at the supporting portion 111 and is located at the opposite side of the light source device 20 for dissipating heat and reducing the weight of the handle. In other words, the plurality of grooves 1112 forms a heat dissipation structure of the light source device 20. Those skilled in the art will appreciate that the grooves 1112 facilitates heat dissipation and reduces mass, but does not constitute a limitation of the handle 11, the handle 11 also may be arranged to have a plane structure that does not affect the implementation of the present invention.

According to this preferred embodiment of the present invention, the set light fixture further comprises at least one engaging element arranged between the adjustment supporting device 10 and the light source device 20 for quick disassembly and installation of the light source device 20 to the adjustment supporting device 10. The engaging element can be embodied as Velcro members, which are respectively arranged at the back surface of the light source device 20 and the supporting portion 111 of the handle 11 of the adjustment supporting device 10, such that the light source device 20 can be simply attached to or detached from the handle 11 by the attachment or separation of the Velcro members.

In accordance with this preferred embodiment of the present invention, the light control driver 30 comprises a driver body, at least an adjusting component and a protective cover. The adjusting component is arranged at the driver body, which is arranged at an edge of the driver body and is protruded therefrom for convenient operation. But it is easily damaged by collision during carrying, thus the protective cover is provided with a protrusion which is mated with the adjusting component to protect it. Additionally, the adjusting element can be implemented as at least one knob or at least one switch, such that the protective cover with the protrusion is mated with the knob or the switch to protect the knob or the switch.

According to this preferred embodiment of the invention, the portable power device 40 comprises a battery holder and at least a battery unit. The battery holder is arranged at the light control driver 30. The battery unit is detachably mounted to the battery holder. It is worth mentioning that when applied to different cameras, the battery holders can also be of different types to fit battery power sources of different types of cameras, such as a battery power source of a U-type camera, a battery power source of a V-type camera, and a battery power source for a V-type camera without a power interface. That is to say, the present invention provides three types of battery holders for replacement in accordance with existing battery models to increase the utility of the kit of the present invention, as shown in FIG. 24 to FIG. 26.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention comprises all modifications encompassed within the spirit and scope of the following claims.

1-59. (canceled)

60. A set light fixture, comprising:
an adjustment supporting device;
a light source device detachably mounted to said adjustment supporting device; and
a light control driver arranged at said adjustment supporting device and electrically connected to said light source device.

61. The set light fixture, as recited in claim 60, wherein said adjustment supporting device comprises a handle, a holder and an adjustment screw connecting said handle to said holder, wherein said light source device is arranged at said handle, wherein said handle is rotatably mounted to said holder to define an adjustable angle between said handle and said holder.

62. The set light fixture, as recited in claim 61, wherein said light source device comprises a bottom plate, a plurality of LED illumination members arranged in an array at said bottom plate, and a protective film which is covered on said plurality of LED illumination members by a vacuum molding process.

63. The set light fixture, as recited in claim 62, wherein said light source device further comprises a plurality of wrap corners which is arranged at corresponding corner positions of said bottom plate and a plurality of supporting frames each of which is arranged between two said wrap corners.

64. The set light fixture, as recited in claim 62, wherein said handle comprises a supporting portion, a first adjusting portion extended from said supporting portion and a first angle adjustment gear arranged at said first adjusting portion, wherein said holder comprises a body portion, a second adjusting portion extended from said body portion of said holder, and a second angle adjustment gear arranged at said second adjusting portion, wherein said first angle adjustment gear is engaged with said second angle adjustment gear to adjust said adjustable angle between said handle and said holder.

65. The set light fixture, as recited in claim 64, wherein said handle further comprises at least two clamping members clamped on said light source device and at least two fixing members fixing said at least two clamping members to said supporting portion respectively so as to retain said light source device on said supporting portion.

66. The set light fixture, as recited in claim 64, wherein said bottom plate is made of a flexible material.

67. The set light fixture, as recited in claim 64, wherein said support frame is embodied as a gooseneck hose.

68. The set light fixture, as recited in claim 64, wherein said light source device is one of a monochromatic LED flexible light board and a dichromatic LED flexible light board.

69. The set light fixture, as recited in claim 60, further comprising an adapter device which supports said light source device, wherein said adjustment supporting device comprises a handle, a holder and an adjustment screw connecting said handle with said holder, wherein said adapter device is detachably mounted to said handle, wherein said handle is rotatably mounted to said holder to define an adjustable angle between said handle and said holder.

70. The set light fixture, as recited in claim 69, wherein said adapter device comprises an adapter plate and a rotation device arranged at said adapter plate to rotatably connect said adapter plate with said light source device.

71. The set light fixture, as recited in claim 70, wherein said rotation device comprises a pressing plate, a screw, a nut, and a rotation member, wherein said screw is fixed to said adapter plate by said pressing plate, wherein said rotating element, which passes through said screw, is retained in position via said nut and is coupled to said light source device.

72. The set light fixture, as recited in claim 70, wherein said adapter plate has a plurality of threaded holes of different specifications, wherein said adapter device further comprises a plurality of magnetic units embedded in a side of said adapter plate adjacent to said adjustment supporting device.

73. The set light fixture, as recited in claim 71, wherein said light source device is an LED box lamp comprising a bottom case, a plurality of LED illumination members, a light filter, and two visors, wherein said plurality of LED illumination members are arranged at said bottom case, and said light filter cover is disposed on said plurality of LED illumination members, wherein said two visors are respectively arranged at both sides of said LED illumination members and said light filter.

74. The set light fixture, as recited in claim 73, wherein said light source device further comprises two sets of movable members respectively arranges said two visors at said bottom case, wherein each set of said movable members comprises a rotation shaft and a plurality of rotation fixing members, wherein each of said visors is fixed to said rotation fixing members, and each of said rotation fixing member is movably mounted at said rotation shaft, wherein said visors are capable of being rotated with respect to said rotation shaft towards said bottom case.

75. The set light fixture, as recited in claim 71, wherein said light source device is an LED zoom lamp comprising a heat sink casing and a plurality of LED zoom spotlights, wherein a plurality of said LED zoom spotlights are respectively arranged at said heat sink casing.

76. The set light fixture, as recited in claim 75, wherein said heat sink casing comprises an upper housing having a plurality of placing holes for receiving said LED zoom spotlights, a lower housing connected to said upper housing, a plurality of fans connected to said lower housing, a plurality of locking covers, a plurality of rubber rings, and a plurality of gaskets, wherein each of said locking covers is respectively locked to said placing hole of said upper housing, and press-fits and locks said corresponding gasket and said corresponding rubber ring respectively to said placing hole of said upper housing to achieve a waterproof and shockproof function.

77. The set light fixture, as recited in claim 75, wherein each of said LED zoom spotlights comprises a supporting base, at least an LED illumination member arranged at said supporting base, and a light cover which is a zoom lens arranged above said at least an LED illumination member.

78. The set light fixture, as recited in claim 64, wherein said light source device is embodied as an LED flag board light comprising a bottom plate, a plurality of LED illumination members arranged in an array arrangement at said bottom plate, a protective film covered on said plurality of said LED illumination members by a vacuum molding process, and a plurality of attaching members provided at edges of front and back surfaces of said bottom plate.

79. The set light fixture, as recited in claim 78, comprising a supporting set which comprises an upper rod, a lower rod, two side rods, and a connecting rod, wherein said light source device is fixed to said upper rod and said lower rod, wherein said two side rods are connected to two ends of each of said upper rod and said lower rod, wherein said connecting rod is connected to a middle of said lower rod, wherein each of said two side rods is a telescopic rod.
